(19) United States
(12) Patent Application Publication
(10) Pub. No.: US 2023/0244836 A1
(43) Pub. Date: Aug. 3, 2023

(54) SYSTEMS AND METHODS FOR PIPELINE RISK MODELING

(71) Applicant: Rezatec Limited, Oxfordshire (GB)

(72) Inventors: Fabio Veronesi, London (GB); Aleksandra Karnicka, Wantage (GB); Craig Pinhorne, Newbury (GB)

(21) Appl. No.: 17/589,792

(22) Filed: Jan. 31, 2022

(51) Int. Cl. G06F 30/27

(52) U.S. Cl. CPC G06F 30/27; G06F 2113/14

(57) ABSTRACT

A system and method for reducing pipe failure risk. The method may comprise receiving an image depicting an overhead view of an area and a set of pipe data indicating characteristics for an underground pipe that is located within the area; receiving a set of geospatial data for a geographic region in which the area is located; segmenting the set of pipe data and the set of geospatial data for the geographic region into a plurality of segments to generate a feature vector, each of the plurality of segments corresponding to a separate portion of the underground pipe; executing a machine learning model using the feature vector to generate failure likelihood data for the separate portions of the underground pipe; determining visual indicators that correspond to the generated failure likelihood data for the separate portions of the underground pipe; and generating an overlay from the visual indicators.

### BACKGROUND

In general, water companies tend to be reactive when dealing with issues in their piping network, meaning companies repair pipes only after customers alert them of issues with their supply. Such issues can range from minor to major leaks in the pipes that wastes water and may reduce the available water pressure that consumers can have in their homes or office complexes. Some companies attempt to proactively combat these leaks by identifying risks for leaks before the leaks occur and replacing the portions of the pipe that are most at risk. This proactive approach can be expensive and is reliant on the human judgment and error of technicians that walk over around the pipes over night with special acoustic leak detectors. However, even the specialized acoustic leak detectors can be prone to error and can miss leaks before they have occurred, resulting in significant portions of the pipe leaking anyway.

### SUMMARY

Aspects of example embodiments of the present disclosure relate generally to providing an improved pipeline risk modeling system that captures geospatial data of a geographic region as well characteristics of different portions of a pipe that is within the geographic region. The pipeline risk modeling system may estimate a likelihood that the individual portions of the pipe will experience a failure (e.g., a fault or a leak). Advantageously, the improved pipeline risk modeling system models the pipe as well as the geographic region of the area in which the pipe is located to characterize the failure likelihood of the pipe more accurately and earlier than acoustic leak detectors of conventional failure detection systems. The system can help companies decrease the cost of network surveillance and also improve the effectiveness of replacement campaigns (e.g., companies may only inspect and/or replace important assets that are likely to experience a failure), thus allowing companies to better target portions of their pipeline for renovations. The system, method, apparatus, and computer-readable medium described herein provide a technical improvement to modeling pipeline risks.

In accordance with some embodiments, the present disclosure discloses a method for reducing pipe failure risk. The method may include receiving, by a processor, an image (e.g., a satellite image) depicting an overhead view of an area and a set of pipe data indicating characteristics for an underground pipe that is located within the area; receiving, by the processor, a set of geospatial data for a geographic region in which the area is located; segmenting, by the processor, the set of pipe data and the set of geospatial data for the geographic region into a plurality of segments to generate a feature vector, each of the plurality of segments corresponding to a separate portion of the underground pipe; executing, by the processor, a machine learning model using the feature vector to generate failure likelihood data for the separate portions of the underground pipe; determining, by the processor, visual indicators that correspond to the generated failure likelihood data for the separate portions of the underground pipe; and generating, by the processor, an overlay from the visual indicators, the overlay comprising the visual indicators for pixels of the image that correspond to the separate portions of the underground pipe. In some embodiments, the set of spatial data includes ground motion radar data for the geographic image.

In accordance with some other embodiments, the present disclosure discloses a system for reducing pipe failure risk. The system may include a processor configured by machine-readable instructions to receive an image depicting an overhead view of an area and a set of pipe data indicating characteristics for an underground pipe that is located within the area; receive a set of geospatial data for a geographic region in which the area is located; segment the set of pipe data and the set of geospatial data for the geographic region into a plurality of segments to generate a feature vector, each of the plurality of segments corresponding to a separate portion of the underground pipe; execute a machine learning model using the feature vector to generate failure likelihood data for the separate portions of the underground pipe; determine visual indicators that correspond to the generated failure likelihood data for the separate portions of the underground pipe; and generate an overlay from the visual indicators, the overlay comprising the visual indicators for pixels of the image that correspond to the separate portions of the underground pipe.

In accordance with yet other embodiments, the present disclosure discloses a non-transitory computer-readable media having computer-executable instructions embodied thereon.

The computer-executable instructions when executed by a processor, cause the processor to perform a process for reducing pipe failure risk, the method receiving an image depicting an overhead view of an area and a set of pipe data indicating characteristics for an underground pipe that is located within the area; receiving a set of geospatial data for a geographic region in which the area is located; segmenting the set of pipe data and the set of geospatial data for the geographic region into a plurality of segments to generate a feature vector, each of the plurality of segments corresponding to a separate portion of the underground pipe; executing a machine learning model using the feature vector to generate failure likelihood data for the separate portions of the underground pipe; determining visual indicators that correspond to the generated failure likelihood data for the separate portions of the underground pipe; and generating an overlay from the visual indicators, the overlay comprising the visual indicators for pixels of the image that correspond to the separate portions of the underground pipe.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an illustration of a pipe risk modeling system, in accordance with some embodiments.

FIG. 2 is an image of an overhead view of an area based on failure likelihoods of various portions of an underground pipe, in accordance with some embodiments.

FIG. 3 is an image of an overhead view of an area based on clustered failure likelihoods of various portions of the underground pipe, in accordance with some embodiments.

FIG. 4 is an image of an overhead view of the area based on the consequence severity of various portions of the underground pipe, in accordance with some embodiments.

FIG. 5 is an image of an overhead view of the area based on criticality scores for various portions of the underground pipe, in accordance with some embodiments.

FIG. 6 is an example of a training data set for training a machine learning model to generate failure likelihood data for various portions of an underground pipe, in accordance with some embodiments.

FIG. 7 is an example method for pipe risk modeling, in accordance with some embodiments.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Further, in the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

As previously mentioned, systems that attempt to detect and predict early failures in a piping network are often forced to rely on time-consuming and often inaccurate detection and prediction methods. For example, systems may implement boots-on-the-ground surveys in which expert surveyors use leak detection devices along marked pipelines to detect leaks in the pipelines. While these surveyors can detect leaks that already exist, they generally do not predict whether leaks are likely to occur. Because the surveyors are human, there is also an element of human error in the leak detection methods, so there are often cases in which active leaks are not detected in a pipe or the surveyors make improper leak predictions (e.g., a prediction that a leak will occur even if the pipe is still structurally sound or a prediction that a leak will not occur even though a leak is imminent). These errors in judgment or improper device readings often result in companies wasting resources when replacing portions of the pipe that are not failing and ignoring other portions of the pipe for which a leak is imminent or already occurring. Thus, companies need a system that accurately predicts failures in their water pipe network to both avoid downtime in their system and to avoid wasting resources and replacing portions of the network that do not need to be replaced.

Implementations of the systems and methods discussed herein overcome these technical deficiencies because they provide an improved method for determining failure likelihoods in a pipeline using artificial intelligence processing. A computer may train a machine learning model to use pipe data (e.g., pipe length, diameter, thickness, etc.) and geospatial data (e.g., terrain motion, vegetation presence, soil properties, terrain slope, etc.) to output failure likelihood data (e.g., a likelihood that the pipe will experience a failure within a set time period). The computer may train the machine learning model to make predictions for individual portions of the pipe by segmenting the input pipe and geospatial data based on the portions of the pipe with which the data is associated. Accordingly, upon receiving a request for pipeline failure likelihood data for a particular geographic region, the computer may execute the trained machine learning model using pipe and geospatial data from the region to obtain data indicating the likelihood that a failure will occur in individual portions of the pipe in the region. The computer may then provision the output data to the requesting computer so a user may inspect or address any portions of the pipe for which a failure is likely.

Including geospatial data as input data into the machine learning model improves the accuracy of the machine learning model's predictions compared to any predictions that simply evaluate the current state of a pipeline. For example, a leak detection device may evaluate the current state of the pipe without taking into any environmental factors of the surrounding areas. By including the geospatial data of the area in which the pipe is located, the machine learning model may more accurately predict that failures are likely to occur than current leak detection methods and devices.

Advantageously, the embodiments described herein can predict which portions of the pipeline are likely to experience failures over time, fusing geospatial and pipe data feeds with advanced artificial intelligence. The embodiments help companies decrease the cost of network surveillance and also improve the effectiveness of replacement campaigns (e.g., a company may only replace the most critical portions of a pipe), thus allowing companies to better target their investments.

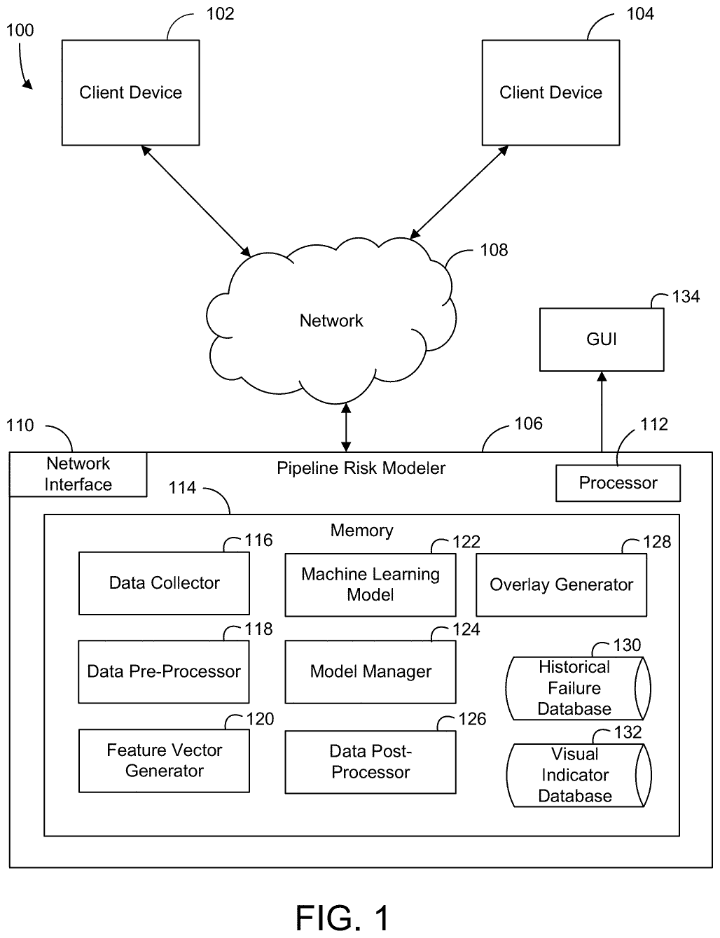

Referring now to FIG. 1, an illustration of an example pipe risk modeling system 100 is shown, in some embodiments. In brief overview, system 100 can include two client devices 102 and 104 that communicate with a pipeline risk modeler 106 over a network 108. These components may operate together to generate an overlay with failure likelihood data for different portions of a pipe (e.g., an above ground or underground pipe) in a geographical region. As described herein, an underground pipe is a pipe that is located substantially or fully underground and an above ground pipe is a pipe that is located substantially or fully above ground. Such pipes may be used to transport wastewater and/or potable water. System 100 may include more, fewer, or different components than shown in FIG. 1. For example, there may be any number of client devices or computers that make up or are a part of pipeline risk modeler 106 or networks in system 100.

Client devices 102 and 104 and/or pipeline risk modeler 106 can include or execute on one or more processors or computing devices and/or communicate via network 108. Network 108 can include computer networks such as the Internet, local, wide, metro, or other area networks, intranets, satellite networks, and other communication networks such as voice or data mobile telephone networks. Network 108 can be used to access information resources such as web pages, websites, domain names, or uniform resource locators that can be presented, output, rendered, or displayed on at least one computing device (e.g., client device 102 or 104), such as a laptop, desktop, tablet, personal digital assistant, smartphone, portable computers, or speaker. For example, via network 108, client devices 102 and 104 can request, from pipeline risk modeler 106, failure likelihood data about pipelines in different geographic regions that are depicted in aerial images of the regions.

Each of client devices 102, 104, and/or pipeline risk modeler 106 can include or utilize at least one processing unit or other logic devices such as a programmable logic array engine or a module configured to communicate with one another or other resources or databases. The components of client devices 102 and 104 and/or pipeline risk modeler 106 can be separate components or a single component. System 100 and its components can include hardware elements, such as one or more processors, logic devices, or circuits.

Pipeline risk modeler 106 may comprise one or more processors that are configured to generate failure likelihood data for individual portions of a pipe based on pipe data and geospatial data. Pipeline risk modeler 106 may comprise a network interface 110, a processor 112, and/or memory 114. Pipeline risk modeler 106 may communicate with client devices 102 and 104 via network interface 110. Processor 112 may be or include an ASIC, one or more FPGAs, a DSP, circuits containing one or more processing components, circuitry for supporting a microprocessor, a group of processing components, or other suitable electronic processing components. In some embodiments, processor 112 may execute computer code or modules (e.g., executable code, object code, source code, script code, machine code, etc.) stored in memory 114 to facilitate the activities described herein. Memory 114 may be any volatile or non-volatile computer-readable storage medium capable of storing data or computer code.

Memory 114 may include a data collector 116, a data pre-processor 118, a feature vector generator 120, a machine learning model 122, a model manager 124, a data post-processor 126, an overlay generator 128, a historical failure database 130, and a visual indicator database 132. In brief overview, components 116-132 may cooperate to collect different types of data and images of a geographical region. Components 116-132 may generate a feature vector from data and input the feature vector into machine learning model 122, which may have been trained to output failure likelihood data for individual portions of a pipe. Machine learning model 122 may output failure likelihood data for the pipe and components 116-132 may process the data to generate one or more overlays with the processed data for display on a graphical user interface (GUI) 134. Components 116-132 may place the overlays over an overhead image of the area in which the pipe is located and a user may toggle through the different overlays on the GUI 134 to view different types of failure likelihood data for the pipe that indicate the portions of the pipe that need to be inspected and/or replaced.

Data collector 116 may comprise programmable instructions that, upon execution, cause processor 112 to collect geographical data from different sources. For example, data collector 116 may receive an image of a geographical area. The image may be an optical photograph of the area taken from above the area such as by a satellite or another flying vehicle. The area may include a metropolitan region that includes one or more buildings and/or a forested region that includes various degrees of vegetation. Data collector 116 may receive the image of the area from an entity or company that specializes in capturing and transmitting such images. For example, data collector 116 may receive the image from an ESA Sentinel-2 satellite. Additionally, in some embodiments, data collector 116 may receive photographs or radar data of the area such as photographs or radar data collected from ESA Sentinel-1 and/or ALOS-2 PALSAR satellites.

Data collector 116 also receives pipe data for a pipe that is within the area shown in the image. The pipe may be an underground or above ground pipe that is configured to carry water from a water plant to various destinations, such as to houses or commercial businesses. The pipes may transport wastewater and/or potable water. The pipe data may include data about the pipe such as, but not limited to, the lengths of segments of the pipe (e.g., segments of the pipe that have been coupled together or segments of the pipe that have been divided by data collector 116 or the source of the data based on their length and position within the pipe), the diameter of the pipe, the age of the pipe, the thickness of the pipe, the material of the pipe, etc. The pipe data may be data for individual portions (e.g., segments) of the pipe. Data collector 116 may receive the pipe data from an online database, the entity that owns the pipe, or from a data source provider that collects and maintains records about pipes around the country or world.

Data collector 116 receives geospatial data for a geographic region of the area. The geographic region may be the geographic area and/or coordinates of the area. The geospatial data may include information about the area that is depicted in the image. Examples of geospatial data that data collector 116 receives include, but are not limited to, terrain motion data, vegetation presence data, soil property data, and terrain slope data.

Terrain motion data may include movement data of the ground surface (either subsidence or uplift) measured from a time series of ESA Sentinel 1 radar imagery. Observed movement of the ground surface may be a proxy indicator for movement below the surface that indicates potential impacts to subsurface infrastructure. Terrain motion data may include timeseries data indicating the movement of the surface over time. The terrain motion data may include timeseries data captured or determined for various time intervals depending on the desired resolution of the data. For example, the timeseries data may include movement of the terrain within five-second intervals, ten-second intervals, one-minute intervals, etc.

In some embodiments, data collector 116 divides the pipe data and geospatial data into portions to align with the localized measurements of the terrain motion. For example, data collector 116 may identify sections of the terrain of the area that move together. Data collector 116 may identify the portions of the pipe that are closest to the individual sections of the terrain (e.g., within a predetermined distance and/or directly under the terrain section). Data collector 116 may generate and/or assign unique pipe portion identifiers for each of the identified portions. Data collector 116 may then assign the pipe data and/or geospatial data to the pipe portion identifiers based on the pipe data being associated with (e.g., characterizing) the portion of the pipe represented by the unique segment identifier and/or the geospatial data being associated with an area within a predetermined distance of the pipe portion of the pipe. Thus, data collector 116 may divide the pipe data and geospatial data based on the terrain movement data to better align with terrain movement data and account for different variations in likelihood of failure between the portions.

Vegetation presence data may include data about the vegetation (e.g., trees and bushes) that is in proximity to the pipe. The vegetation presence of the area around the pipe may be important because the proximity of large vegetation, such as trees and bushes, can potentially impact buried pipelines in a variety of ways. For example, the growth and movement of roots into pipelines can cause blockages, ruptures, and leakage. The impact of vegetation may be higher for unpressurized sewer lines that are more easily penetrated by roots. However, the growth of roots can still lead to instability of the subsurface, which can trigger terrain movement and cause failures in pressurized or other types of pipes as well. In some cases, the root growth in temperate climates is typically in the top 1-2 m of soil, so the direct impact to deeper pipelines may be limited.

In some embodiments, data collector 116 divides the pipe into portions based on the vegetation surrounding the different portions of the pipe. For instance, data collector 116 may identify regions of the area depicted in the picture that have a significant amount of vegetation, such as a forested region, and assign a unique value to that portion of the pipe and identify a municipal area with little vegetation and more buildings, and assign a unique value to the municipal area. Data collector 116 may do so using object character recognition techniques on the image. Data collector 116 may divide the pipe based on variations in the vegetation that surrounds the pipe to account for different variations in likelihood of failure between the portions.

In some embodiments, data collector 116 receives data related to the soil in which the pipe is buried or laid. The type of soil where pipe is laid may be important because certain materials tend to corrode in particular conditions related to soil pH and drainage. Soil data are derived from global open data and include the following sand, silt, and clay percentages, organic carbon content, and pH level. Each of these variables may be available at three depths: 5, 60, and 200 centimeters. Data collector 116 may receive such soil data from data source providers such as, but not limited to, the gNATSGO database.

In some embodiments, data collector 116 receives data related to the slope and/or elevation of the area in which the pipe is laid. Slope and elevation data may be important because pipes laid at an angle are subjected to a differential in hydraulic pressure that could increase the probability of ruptures in the pipe. In some embodiments, data collector 116 derives the data for the slope and/or elevation from an open-source global data set (e.g., USGS National Elevation dataset) and calculates the slope and/or elevation from a digital terrain model (e.g., identify points in the model and calculate the slope based on the various points on the model). In some embodiments, data collector 116 receives raw values for the slope or elevation. Data collector 116 may receive such raw values for individual coordinates, portions of the area in which the pipe is located, or for the area as a whole. Data collector 116 may receive the values from online data source providers. Data collector 116 may receive any type of other geospatial data, such as weather and climate data.

Data pre-processor 118 may comprise programmable instructions that, upon execution, cause processor 112 to process the data that data collector 116 receives (e.g., filter out incomplete or inapplicable data from the data sets). For example, data collector 116 may receive an image of a geographical area. Data pre-processor 118 may determine if geospatial data from the set of geospatial data is a distance from the pipe below a distance threshold. The distance threshold may be a defined threshold stored in memory 114 of pipeline risk modeler 106. Data pre-processor 118 may identify the geographical coordinates that correspond to the individual pieces of geospatial data (e.g., the coordinates of the vegetation data, the terrain movement data, the soil data, and/or the terrain slope data) and the coordinates of the pipe (e.g., coordinates of various portions of the pipe). For one data point of the geospatial data (e.g., geospatial data at set of coordinates), data pre-processor 118 may determine the distances between the coordinates for the data point and the coordinates for different portions of the pipe using a distance formula. Data pre-processor 118 may then compare the determined distances to a threshold. If data pre-processor 118 determines none of the distances are below a threshold, data pre-processor 118 discards the data point of the geospatial data (e.g., remove the data point from memory 114 or otherwise exclude the data point from a data set that is being used to generate failure likelihood data for a pipe). Data pre-processor 118 may similarly determine whether the data points of the geospatial data are within a distance of the pipe below a threshold and discard any data that is not close to the pipe. Thus, data pre-processor 118 can filter out the geospatial data that is likely not relevant to determining the failure likelihood for the pipe. By doing so, data pre-processor 118 can minimize the data that is put into machine learning model 122 while still enabling machine learning model 122 to generate accurate failure likelihood data.

Data pre-processor 118 may determine if the pipe data for the pipe is complete. For example, data pre-processor 118 may store rules that indicate whether pipe data that the data pre-processor 118 receives is complete. An example rule may be that data for a particular portion of a pipe is complete if the data includes values for the material, diameter, and age of the portion of the pipe. The rule may also include a requirement that the data include an identifier indicating whether the portion of the pipe is active or replaced. The rule may include requirements that the data include any type or any number of values. Data pre-processor 118 may identify the values (or lack thereof) for each type of pipe data and generate a binary indicator indicating whether the data point for the section of the pipe has a value for the data type. Data pre-processor 118 may compare the binary values to the rule to determine if the rule is satisfied. Thus, data pre-processor 118 may determine if the pipe data is complete and avoid using incomplete data that may skew the accuracy of failure likelihood data for the portion of the pipe for which there is incomplete data.

If data pre-processor 118 determines data is missing that is required by a rule, data pre-processor 118 may discard the data for the portion of the pipe to which the geospatial data corresponds. Data pre-processor 118 may discard the data by removing the data from memory 114 of pipeline risk modeler 106 or otherwise excluding the data from the dataset that is being used to predict failure likelihood data for the pipe. In doing so, data pre-processor 118 may discard all the pipe data for the portion of the pipe. Data pre-processor 118 may also discard the geospatial data for the portion of the pipe. For example, data pre-processor 118 may identify any geospatial data that is within a threshold distance of the portion of the pipe as being associated with the portion of the pipe. Data pre-processor 118 may discard the identified geospatial data responsive to determining the geospatial data is within the threshold distance of the portion of the pipe with incomplete pipe data. Data pre-processor 118 may iteratively evaluate and, when applicable, discard geospatial data for each portion of the pipe for which pipeline risk modeler 106 receives data.

In some embodiments, before discarding geospatial data for a portion of the pipe, data pre-processor 118 may determine if the geospatial data is within the distance threshold of another portion of the pipe. For example, if the geospatial data has coordinates that are within five meters of multiple defined portions of the pipe, data pre-processor 118 may determine the geospatial data will still be used in the dataset with the portions of the pipe that have or that are otherwise associated with a complete set of pipe data and that are within the distance threshold of the geospatial data. For example, the distance threshold may be five meters. Data pre-processor 118 may identify geospatial data that is within five meters of multiple defined portions of the pipe. Data pre-processor 118 may identify the portions of the pipe for which there is not a complete set of pipe data and/or geospatial data and the portions of the pipe for which there is a complete set of pipe data and/or geospatial data. Because data pre-processor 118 has identified portions of the pipe for which there is a complete set of pipe data, data pre-processor 118 may not discard the associated geospatial data and instead only use the geospatial data for the portions of the pipe for which there is a complete set of pipe data.

Feature vector generator 120 may comprise programmable instructions that, upon execution, cause processor 112 to generate a feature vector from the pre-processed pipe and/or geospatial data. Feature vector generator 120 may segment the data into a feature vector. Feature vector generator 120 may segment the data into a feature vector based on the portions of the pipe to which the data corresponds. For example, feature vector generator 120 may identify unique identifiers of portions (e.g., divided portions) of a pipe. In some embodiments, feature vector generator 120 only identifies unique identifiers of portions of the pipe for which pipe data and/or geospatial data has not been discarded, as described above. Feature vector generator 120 may identify pipe data from a set of pipe data for the pipe that characterizes the individual portions of the pipe and assign the pipe data to the unique identifiers for the portions of the pipe. Similarly, feature vector generator 120 may identify geospatial data that has coordinates within a distance threshold of the different portions of the pipe. Feature vector generator 120 may identify the unique identifiers for the different portions of the pipe with which the geospatial data is within a distance threshold and assign the geospatial data to the unique identifiers of the portions of the pipe to which the geospatial data corresponds.

In some embodiments, feature vector generator 120 assigns the pipe data and the geospatial data to unique identifiers of segments of a pipe by grouping the pipe data, the geospatial data, and the unique identifiers that are assigned together in a feature vector. For example, feature vector generator 120 may assign a unique identifier and pipe and geospatial data to sequential index values of a feature vector (e.g., the first value of the feature vector may be the unique identifier, the second through fifth values may be different pipe data characteristics, and the sixth through tenth values may be geospatial characteristics (e.g., variables)). After adding the data for one portion of the pipe, feature vector generator 120 may similarly add data for additional portions of the pipe in the same or in a similar manner. In this way, feature vector generator 120 may generate a feature vector such that machine learning model 122 may generate failure likelihood data for individual portions of the pipe.

In some embodiments, if data for an individual portion of the pipe has been discarded for having an incomplete set of pipe and/or inapplicable geospatial data (e.g., geospatial data that is too far from a portion of the pipe), feature vector generator 120 sets the index values for the portion of the pipe as null values. Feature vector generator 120 may do so by setting all the values to null including the unique identifier for the portion of the pipe or by including the unique identifier itself in the feature vector and setting the data for the portion of the pipe to null. In some embodiments, feature vector generator 120 excludes all the data for the portions of the pipe for which there is incomplete and/or inapplicable data from the feature vector. Instead, feature vector generator 120 adds only the portions for which there is complete data. By doing so, feature vector generator 120 may avoid making predictions for portions of the pipe for which there is incomplete or inapplicable data and/or making predictions for other portions of the pipe that are affected by the incomplete or inapplicable data.

In some embodiments, feature vector generator 120 assigns the pipe data and the geospatial data to the unique identifiers in a spreadsheet. For example, feature vector generator 120 may generate a spreadsheet in which each row includes data for a specific portion of a pipe and each column includes data for specific pipe data or geospatial data for the portions of the pipe. Feature vector generator 120 may identify the pipe data and the geospatial data that is associated with each of the portions of the pipe and insert the identified data into the rows that correspond to the portions of the pipe (e.g., feature vector generator 120 may insert pipe data and geospatial data for a portion of a pipe into the same row as the unique identifier for the portion of the pipe). In some embodiments, feature vector generator 120 inserts data for discarded portions of the pipe into the spreadsheet as null values to avoid processing the incomplete or inapplicable data while maintaining a record of the portion of the pipe (e.g., include the unique identifiers for such portions of the pipe but only add null values for the different columns of the rows). Feature vector generator 120 may insert the different types of data into the spreadsheet such that the columns for the pipe data are next to each other and the columns for the geospatial data are grouped together after the columns for the pipe data. This process may be useful to avoid extra processing that may be caused by reorganizing the data after the pipe data and geospatial data are input into pipeline risk modeler 106 as separate data sets. The generated spreadsheet may be a feature vector that can be input into machine learning model 122 for processing to determine failure likelihood for different portions of the pipe.

In some embodiments, feature vector generator 120 generates a feature vector from the spreadsheet. For example, feature vector generator 120 may extract values from the spreadsheet and concatenate the values to generate a feature vector. In doing so, feature vector generator 120 may assign the values for each row to the feature vector sequentially such that the values for the portions of the pipe are grouped together to determine the failure likelihood data for the different portions of the pipe.

In some embodiments, feature vector generator 120 discards data for portions for the pipe for which there is incomplete or inapplicable data prior to adding the data to the spreadsheet or avoid using such data to generate failure likelihood data. For instance, feature vector generator 120 may insert the data into the different rows of the spreadsheet after filtering the incomplete or inapplicable data out of the data set. By doing so, feature vector generator 120 may avoid inserting incomplete or inapplicable data into machine learning model 122 when processing the spreadsheet.

In some embodiments, feature vector generator 120 may include data for portions of the pipe for which there is incomplete or inapplicable data in the spreadsheet, but not use the data when generating a feature vector. In one example, feature vector generator 120 may label portions of the pipe for which there is incomplete or inapplicable data as discarded in memory 114. When generating a feature vector from the spreadsheet, feature vector generator 120 may identify any rows from the spreadsheet that correspond to a discarded portion of the pipe (e.g., identify rows with a unique identifier that matches a unique identifier that is stored in memory 114 with a discarded identifier) and skip adding data from the identified rows. In some embodiments, feature vector generator 120 may add data for such portions into the feature vector as null values as described above. By doing so, feature vector generator 120 may maintain a record of the data in the spreadsheet that a user may update with additional data to use for a future prediction instead of deleting the data so the data could not be used again.

Machine learning model 122 may comprise programmable instructions that, upon execution, cause processor 112 to generate failure likelihood data (e.g., probabilities that individual portions of a pipe will experience a failure within a set time period) for individual portions of a pipe. Machine learning model 122 may do so based on feature vectors containing pipe data of the pipe and geospatial data of the geographic area around the pipe. Machine learning model 122 may contain or comprise one or more machine learning models (e.g., support vector machines, neural networks, random forests, regression algorithms such as a gradient boosting algorithm, etc.) that can predict failure likelihood data. Machine learning model 122 may be configured to receive feature vectors that are generated by feature vector generator 120 and determine output failure likelihood data using learned parameters and/or weights of machine learning model 122. For example, feature vector generator 120 may execute machine learning model 122 using a feature vector comprising concatenated pipe data and geospatial data for a pipe and machine learning model 122 may output failure likelihood data for individually defined portions of the pipe accordingly.

Model manager 124 may comprise programmable instructions that, upon execution, cause processor 112 to train or otherwise execute machine learning model 122. Model manager 124 may determine if the feature vector that was generated by feature vector generator 120 is being used to train machine learning model 122. Model manager 124 may do so by determining if the data includes any labels that correspond to whether a failure occurred within the portions of the pipe. For example, model manager 124 may parse a spreadsheet to determine if there is a column for “leak” values (e.g., “leak” or “no_leak”) that indicates whether individual portions of the pipe experienced a leak. If model manager 124 identifies such a column, model manager 124 may determine the input feature vector is to be used for training, otherwise, model manager 124 may determine the input feature vector is not to be used for training. In some embodiments, model manager 124 determines if the feature vector is to be used for training based on whether the instructions that model manager 124 is processing include instructions to train machine learning model 122 according to labels indicating whether any leaks occurred in individual portions of the pipe. In some embodiments, model manager 124 determines the feature vector is being used to train machine learning model 122 in response to identifying leak values from the pipe data that model manager 124 receives to make a failure likelihood prediction (e.g., identifying leak values in the data prior to generating a spreadsheet with the data).

Model manager 124 may label the feature vector responsive to determining model manager 124 is training machine learning model 122. Model manager 124 may label the feature vector by inserting leak values indicating whether a leak occurred in the different portions of the pipe into the feature vector or into a column in a spreadsheet that is dedicated to such leak values. Model manager 124 may insert such leak values into a feature vector as a pair with the values for the portion of the pipe and/or into the same row as the other values for the portion of the pipe. Model manager 124 may insert the leak values into the feature vector or spreadsheet such that model manager 124 may later retrieve the values to use to train machine learning model 122 to predict failure likelihoods for the individual portions of the pipe.

In some embodiments, model manager 124 only uses data that has been labeled for training or otherwise labels a training data set if the failures identified in the labels satisfy a criterion stored in memory 114. For example, for a training data set, model manager 124 may check historical failure database 130 (e.g., a relational database that stores a list of failures for individual portions of different pipes and about and reasons for the respective failures) to identify the failures for the portions of the pipe in the data set. Model manager 124 may determine if the failures have coordinates identifying where the failures occurred or a precise address (e.g., an address that can be geocoded such as through an API to a map application) to generate a pair of coordinates from the address. Model manager 124 may also identify the cause of the failure from historical failure database 130 and determine if the failure was caused by human intervention or by environmental factors. Model manager 124 may discard any training data for portions of the pipe that indicates a failure occurred in the portion that was caused by human intervention or where the address is incomplete (e.g., house number is missing) to ensure the accuracy of the training data. Thus, model manager 124 may avoid improperly biasing machine learning model 122 during training.

Model manager 124 may execute machine learning model 122. Model manager 124 may execute machine learning model 122 by inserting the feature vector or spreadsheet into machine learning model 122. Upon executing machine learning model 122, model manager 124 may apply the parameters and weights of machine learning model 122 to the input values. Machine learning model 122 may output a failure likelihood for each of the portions of the pipe (e.g., a likelihood that the respective portion of the pipe will experience a fault, leak, or other failure within a set time period (e.g., one year)) for which model manager 124 input data. In some instances, model manager 124 retrieves the output failure likelihoods (e.g., failure likelihood data) for the different portions of the pipe and trains machine learning model 122 based on the likelihoods.

To train machine learning model 122 based on the output failure likelihoods, model manager 124 may use a backpropagation technique based on the labels for the different portions of the pipe. For example, after receiving the output failure likelihoods, model manager 124 may compare the output with the expected output (e.g., labels indicating whether a failure or “leak” occurred) for the different portions of the pipe. Model manager 124 may then use a loss function or another supervised training technique based on the differences between the two values for the individual portions of the pipe to train machine learning model 122. Model manager 124 may use backpropagation to determine a gradient for the respective loss function and update the weights and/or parameters of machine learning model 122 using the gradient, such as by using gradient descent techniques.

Model manager 124 may determine if machine learning model 122 has an accuracy that exceeds an accuracy threshold. The accuracy threshold may be a defined threshold that is stored in memory 114 that may be used to determine if machine learning model 122 is sufficiently trained to be used to make failure likelihood predictions for new unlabeled datasets. Model manager 124 may determine the accuracy of machine learning model 122 by comparing the output failure likelihoods for the different portions of the pipe with the leak or failure label. Model manager 124 may calculate an average of the differences between the portions of the pipe and the labels to determine the accuracy of machine learning model 122. For example, if the predicted failure likelihood values for two portions of a pipe were 70 percent and 80 percent and both portions had a failure or leak label, model manager 124 may determine the accuracy of machine learning model 122 was 75 percent by calculating the differences between the predictions and the correct value, taking an average of the predictions, and subtracting the average from the value 1. If the same set of data had “no leak” or “no failure” labels, however, model manager 124 may determine the accuracy of machine learning model 122 was 37.5%. Model manager 124 may compare the determined accuracy to the accuracy threshold. If model manager 124 determines the accuracy is not above the accuracy threshold, model manager 124 may repeatedly train machine learning model 122 until model manager 124 determines machine learning model 122 is sufficiently trained (e.g., has an accuracy above the accuracy threshold).

If model manager 124 determines the determined accuracy is above the accuracy threshold, model manager 124 provisions machine learning model 122. Model manager 124 may provision machine learning model 122 by making machine learning model 122 available in a software-as-a-service environment and/or by transmitting machine learning model 122 to an entity requesting machine learning model 122. For example, upon determining machine learning model 122 is sufficiently trained, model manager 124 may receive requests for failure likelihood predictions for different pipes in different regions. Model manager 124 may receive the requests with sets of pipe data and/or geospatial data of the regions and predict failure likelihood data for the different sections of the pipe with machine learning model 122. Model manager 124 may transmit the predicted data back to the requesting device in response to the request. In embodiments in which model manager 124 transmits machine learning model 122 to other devices, such devices may similarly generate feature vectors and/or spreadsheets with pipe data and/or geospatial to make failure likelihood predictions.

In some embodiments, when training machine learning model 122, model manager 124 may train machine learning model 122 by dividing training data into a training time period and a testing time period. For example, model manager 124 may receive pipe data and geospatial data for a particular pipe and/or geographic region over four sequential years. The data may be divided into four data sets, a data set for each of the four years. The data for the first three years may be training data sets and the data for the fourth year may be a test data set. For example, if a water company has recorded pipe failure data for a pipe from 2017 to 2020, all failures recorded in 2020 would be included in the test data set, while failures recorded from 2017 to 2019 are in the training data set. The data may include data from the most recent number (e.g., a predetermined number) of years for which a water company collected failure data. In some cases, the test dataset includes the last year where failures were recorded by a water company, while the training set includes the remaining years. The training data and the test data may each include data for any number of years and/or any other time period (e.g., day, week, month, etc.) depending on the time window for which machine learning model 122 generates failure likelihood data (e.g., if machine learning model 122 is being trained to predict whether a failure will occur within a year, model manager 124 may use year time periods for training while if machine learning model 122 is being trained to predict whether a failure will occur within a month, model manager 124 may use month time periods for training).

In embodiments in which model manager 124 divides data sets into training and testing, model manager 124 may train machine learning model 122 using the data from the training dataset and then test machine learning model 122 using the testing data set. For example, if model manager 124 received separate data sets for a pipe over a four-year period, model manager 124 may generate a feature vector from the data for each of the four years. Model manager 124 may apply labels indicating the correct prediction for a failure likelihood (e.g., an indication of whether a failure occurred in the respective portions of the pipe during the respective years) to the feature vectors for the first three years and train machine learning model 122 based on the three labeled feature vectors. Model manager 124 may then apply the feature vector for the testing time period to machine learning model 122 to obtain failure likelihood predictions for the testing time period. Model manager 124 may compare predicted values to the actual values to determine the current accuracy of machine learning model 122. Model manager 124 may determine if the accuracy exceeds an accuracy threshold by comparing the accuracy to the threshold. In some embodiments, if model manager 124 determines the accuracy exceeds the threshold, model manager 124 may merge or concatenate the data sets for the four years together (e.g., if the four years were 2017 to 2020, merge the failure data from the beginning of 2017 to the end of 2020) and train machine learning model 122 using all the data. Thus, model manager 124 may fit machine learning model 122 to the complete data set.

Advantageously, by training machine learning model 122 in this manner, model manager 124 may provision machine learning model 122 to predict failures for individual portions of pipes over an entire pipe network. Model manager 124 may receive the failure likelihood outputs from machine learning model 122, compare the likelihoods to a flag threshold (e.g., a predetermined flag threshold), and generate flags for each portion of the pipe with a failure likelihood that exceeds the threshold. Thus, model manager 124 may use machine learning model 122 to predict failures in pipe portions that have not necessarily failed in the past but are prone to failure because they share one or more characteristics (e.g., physical characteristics such as material or age and/or environmental characteristics such as corrosive soil) with other pipe portions that have failed in a past observation period.

If model manager 124 determines the data set that was pre-processed by data pre-processor 118 is not being used to train machine learning model 122, model manager 124 executes machine learning model 122. Model manager 124 may execute machine learning model 122 by inputting the spreadsheet or feature vector of pipe and geospatial data into machine learning model 122. Upon executing machine learning model 122, machine learning model 122 may output failure likelihood data for individual portions of the pipe.

Data post-processor 126 may comprise programmable instructions that, upon execution, cause processor 112 to determine visual indicators based on failure likelihood data that is generated by machine learning model 122. Data post-processor 126 may determine visual characteristics for the portions of the pipe. Data post-processor 126 may determine visual characteristics of the pipe based on the failure likelihood for the individual portions. Data post-processor 126 may determine one or more layers of visual characteristics for the individual portions of the pipe based on the portions' respective failure likelihood. In brief overview, the different layers may include failure likelihood, priority risk zones, consequence severity, and/or criticality of failure.

Data post-processor 126 may select visual indicators for the failure likelihood layer based on the predicted failure likelihoods for the individual portions of the pipe. For example, data post-processor 126 may store a set of colors that may each correspond to a different failure likelihood value in visual indicator database 132 (e.g., a relational database that stores relationships between different likelihood of risk values and visual indicators). In some embodiments, the set of colors may correspond to a color scale from blue to red with dark blue corresponding to the lowest failure likelihood and dark red corresponding to the highest failure likelihood. Data post-processor 126 may identify the failure likelihoods for the portions of the pipe from the output of machine learning model 122 and use the failure likelihoods as a look-up to identify the corresponding colors in visual indicator database 132. Data post-processor 126 may retrieve the colors for the different portions of the pipe based on the colors corresponding to a matching value in visual indicator database 132.

Data post-processor 126 may determine the priority risk zone by applying a clustering algorithm to the failure likelihood data. In doing so, data post-processor 126 may create management areas based on failure likelihood data for the different portions of the pipe within the respective area. Data post-processor 126 may group different portions of a pipe based on their proximity to each other and their failure likelihood. Using one example of such a clustering algorithm, data post-processor 126 may group different portions of the pipe together responsive to the portions being within a defined distance range of each other and/or having a failure likelihood within a failure likelihood range. For instance, data post-processor 126 may create a group of portions of a pipe that are within 25-meter range of each other and that have a predicted failure likelihood between 70% and 80%. Using another example clustering algorithm, data post-processor 126 may group portions of a pipe together according to various spatial and/or hydraulics rules. For instance, data post-processor 126 may group portions of a pipe together that have a predicted failure likelihood above a threshold and/or that are immediately adjacent to or within a defined number of pipe portions or within a distance of a pipe portion that is likely to experience a failure. Such may be advantageous because if one portion of a pipe experiences a failure, it may be more likely that the surrounding portions of the pipe will also experience a failure or that the surrounding pipes need to be investigated or replaced to reduce the possibility of a failure in the identified portion of the pipe. Using another example clustering algorithm, data post-processor 126 may identify clusters based on their average failure likelihood exceeding a threshold. For instance, data post-processor 126 may identify individual sub-regions of the area of the pipe that contain failure likelihood data for portions of the pipe that is above or below the threshold. Such areas may be any size.

Upon clustering the portions of the pipe together, data post-processor 126 may select visual indicators for the portions of the pipe based on the clusters. For instance, data post-processor 126 may identify a cluster of pipe portions that have or that are associated with a high likelihood (e.g., a likelihood above a threshold) of experiencing a failure. Accordingly, data post-processor 126 may select a color (e.g., red) that corresponds to having a high likelihood of experiencing a failure from visual indicator database 132. Data post-processor 126 may identify a cluster of pipe portions that have a low likelihood of experiencing a failure. In this case, data post-processor 126 may select a color (e.g., blue) that corresponds to having or being associated with a low likelihood (e.g., a likelihood below a threshold) of experiencing a failure. Data post-processor 126 may select any colors based on the characteristics of such a cluster. Thus, water companies that view the visual indicators can prioritize investigation and pipe repair in the areas of the pipe that are most at risk in their proactive management.

In some embodiments, data post-processor 126 clusters pipe portions based on the district metered areas (DMA) in which they are located. To do so, data post-processor 126 may identify the pipe portions that are within individual district meter areas (e.g., identify pipe portions that have coordinates in different district metered areas or that have a stored association with district metered areas) and determine an average of the failure likelihoods for the different district metered areas. Data post-processor 126 may compare the average to colors in visual indicator database 132 and select the color that corresponds to the average to assign to each of the pipe portions in the district metered areas.

Data post-processor 126 may select visual indicators for the portions of the pipe based on consequence severities for the individual portions of the pipe. Consequence severities may not be dependent on the failure likelihood that is predicted by machine learning model 122, but rather may describe the inherent risk that each portion of the pipe poses to the water company and the community in case of catastrophic failure. Consequence severity values may vary between the entities that request such values. For instance, one entity may only view risks such as disruption to the supply of vulnerable customers (e.g., hospitals or schools in their consequence severity values) as impacting the consequence severity values. Another entity may only view risks such as traffic disruptions as impacting their consequence severity values. Another entity that manages the water network in old towns and cities may view pipes running through the old towns as more at risk because repairing or replacing these would incur additional costs. Accordingly, data post-processor 126 may store different values for the consequence severities for different entities for the different pipe portions, geographic locations, and/or coordinates. Data post-processor 126 may retrieve the values upon receiving a request for consequence severity data and/or other failure likelihood data depending on the entity that is making a request (e.g., use an identifier of the requesting entity in a look-up to identify the consequence severity values for the different portions of the pipe).

In some embodiments, data post-processor 126 determines consequence severity values for the different pipe portions. The consequence severity values may be values between 1 and 100 that indicate the severity of the impact that a failure in the particular portion of the pipe would have if it were to experience a failure. Data post-processor 126 may determine the consequence severity based on the direct cost of response, repair and restoration of a break, and/or the indirect costs of the impact, including the proximity to vulnerable buildings, service disruption to customers, collateral damage and/or transport disruption. Data post-processor 126 may store a machine learning model that is trained to output consequence severity values based on such variables and execute the machine learning model for the individual portions of the pipe based on the data. In another example, cost information may not be available to data post-processor 126. In such instances, or additionally, data post-processor 126 can execute a machine learning model that has been trained to predict consequence severity values for portions of a pipe using pipe diameter, historic volume of water loss, and proximity to vulnerable buildings data (e.g., hospitals or schools).

Data post-processor 126 may select visual indicators for the different portions of the pipe based on the consequence severity values for the different pipe portions. For example, data post-processor 126 may store colors that correspond to the different consequence severity values similar to the colors for the failure likelihood data in visual indicator database 132. Data post-processor 126 may use the consequence severity values in a look-up from visual indicator database 132 to identify the colors that correspond to the consequence severity values for the different portions of the pipe.

In some embodiments, data post-processor 126 can determine criticality scores for the different pipe portions. Data post-processor 126 may do so based on a combination of the consequence severity values and failure likelihood values for the individual portions of the pipe. For example, for a portion of the pipe, data post-processor 126 may identify the failure likelihood and the consequence severity for the portion. Data post-processor 126 may determine an average, a weighted average, a multiple, a sum, or any other operation, for the two values to determine a criticality score for the pipe portion. Data post-processor 126 may similarly determine criticality scores for each of the pipe portions for which data post-processor 126 determined a failure likelihood. Thus, data post-processor 126 may highlight the portions of the pipe that need to be inspected or replaced to improve the overall health of the pipe.

Data post-processor 126 may select visual indicators for the different portions of the pipe based on the criticality scores for the different pipe portions. For example, data post-processor 126 may store colors that correspond to the different criticality scores similar to the colors for the failure likelihood data in visual indicator database 132. Data post-processor 126 may use the criticality scores in a look-up from visual indicator database 132 to identify the colors that correspond to the criticality scores for the different portions of the pipe.

Overlay generator 128 may comprise programmable instructions that, upon execution, cause processor 112 to generate one or more overlays from the visual indicators. Overlay generator 128 may do so by identifying the pixels of the image data collector 116 received that correspond to the portions of the pipe for which failure likelihood data and visual characteristics were generated. Overlay generator 128 may assign the visual indicators to the corresponding pixels and generate an overlay with pixels that mirror the pixels of the image. In embodiments in which overlay generator 128 determines visual indicators for the different layers (e.g., priority risk zones, consequence severity, and/or criticality of failure), overlay generator 128 may similarly generate an overlay for each of the layers. Overlay generator 128 may store the overlays in memory 114 such that the overlays may be retrieved upon receiving a request from a client device.

Overlay generator 128 places the overlays over the image. Overlay generator 128 may place the overlays over the image in response to receiving a request from a client device (or in response to the original request requesting an analysis of the pipe data and geospatial data). Overlay generator 128 may receive a request to see the overlay for one of the layers for which overlay generator 128 determined visual indicators of failure likelihood. Overlay generator 128 may then place the requested overlay over the image of the area such that the user can see the visual indicators over the portions of the pipe and view which portions are most at risk of experiencing a failure and/or need to be addressed. A user viewing the user interface may select an option to view another of the layers. In response to this request, overlay generator 128 may remove the initial overlay or visual indicators from the user interface and place the new requested overlay over the image, thus toggling between the different visual indicators and/or overlays to give the user a broad view of the failure likelihood in different portions of the pipe. Overlay generator 128 may toggle between any number of visual indicators or overlays.

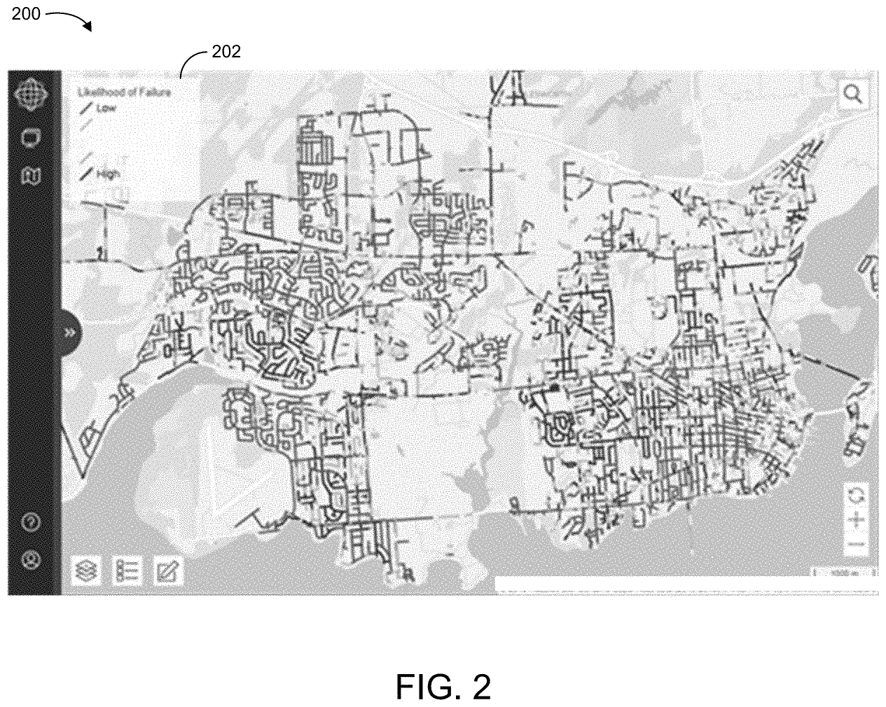

Referring now to FIG. 2, a user interface 200 of an overhead view of a geographic region illustrating a mapping of the failure likelihoods of various portions of an underground pipe of the geographic region is shown, in accordance with some embodiments. For example, user interface 200 illustrates a geographic region including a municipal area and a wooded area within the geographic region. User interface 200 also illustrates a pipeline that runs underground in the geographic region. The pipeline may be outlined (e.g., a line indicating the location of the pipeline may be overlaid onto user interface 200) and include visual indicators (e.g., color indicators) indicating the likelihood of failures at different portions of the pipeline. A data processing system may determine the visual indicators by executing a machine learning model using pipe data and geospatial data for the pipe and region illustrated on user interface 200 as described herein. By viewing user interface 200, a user may be able to see the different portions of the underground pipe that need to be replaced or inspected before they fail and cause the piping system to go down (e.g., the water may need to be turned off to avoid excess leaking). User interface 200 includes a key or legend 202 that indicates the visual indicators for the different failure likelihoods.

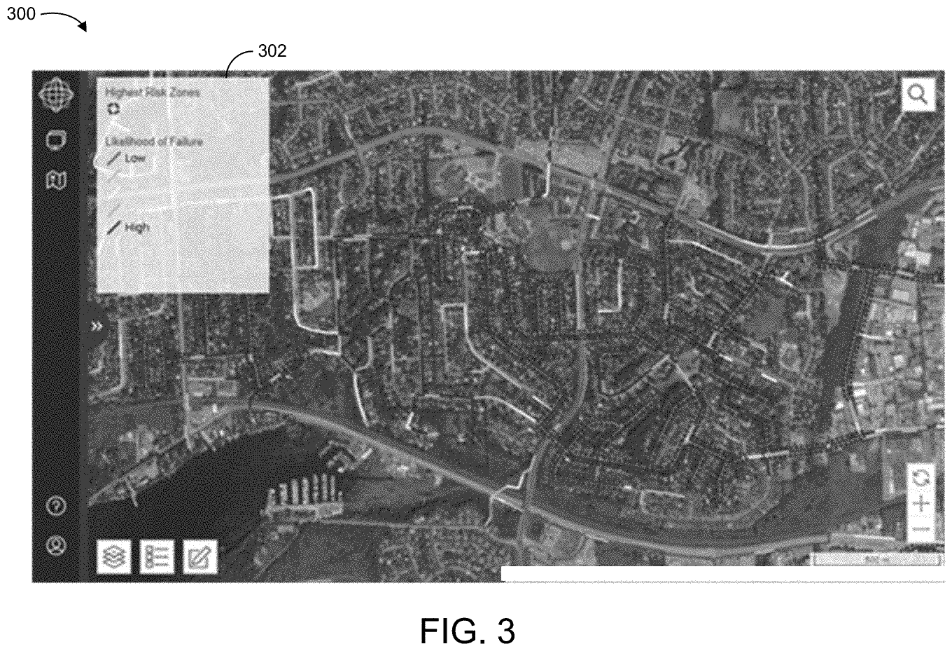

Referring now to FIG. 3, a user interface 300 of an overhead view of a geographic region illustrating a mapping of the failure likelihoods of various portions of an underground pipe of the geographic region determined based on clustered failure likelihoods of various portions of the underground pipe is shown, in accordance with some embodiments. Similar to user interface 200, shown and described with reference to FIG. 2, user interface 300 illustrates a geographic region including a municipal area and a wooded area. User interface 300 also illustrates a pipeline that runs underground in the geographic region. The pipeline may be outlined and include visual indicators indicating the likelihood of failures at different portions of the pipeline. A data processing system may determine the visual indicators by executing a machine learning model using pipe data and geospatial data for the pipe and region. The data processing system may then use a clustering algorithm to group the portions of the pipe based on the likelihood that those portions will experience a failure. For example, the data processing system may cluster portions of the pipe together that are within a set geographical distance of each other and that have failure likelihoods that are within specific ranges or that have averages within specific ranges. The data processing system may select visual indicators for the clusters of the portions of the pipe and include the selected visual indicators on user interface 300 to show a user the general areas that pipe failures are likely to occur. User interface 300 includes a key or legend 302 that indicates the visual indicators for the different failure likelihoods.

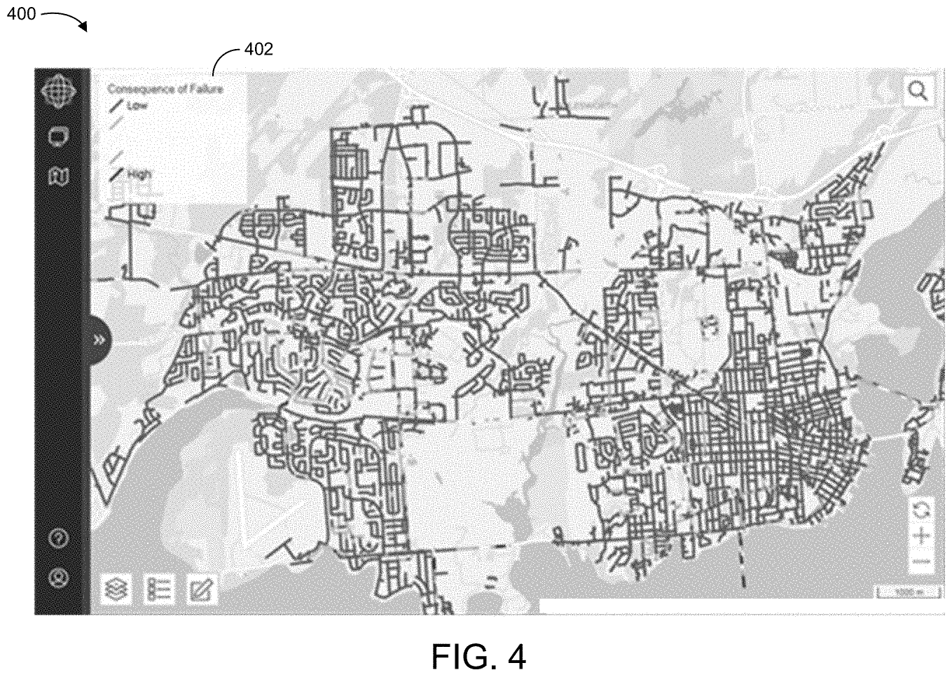

Referring now to FIG. 4, a user interface 400 of an overhead view of a geographic region illustrating a mapping of the consequence severity for various portions of an underground pipe in the geographic region is shown, in accordance with some embodiments. Similar to user interface 200, shown and described with reference to FIG. 2, user interface 400 illustrates a geographic region including a municipal area and a wooded area within the geographic region. User interface 400 also illustrates a pipeline that runs underground in the geographic region. The pipeline may be outlined and include visual indicators indicating the consequence severity at different portions of the pipeline. The consequence severity for a specific portion of the pipe may indicate how bad the consequences would be if the portions of the pipe failed (e.g., how expensive it would be to fix the portion of the pipe if the pipe failed, the vulnerability of population that would be affected by the portion of the pipe failing, the likelihood of the failure affecting traffic, a combination of such elements, etc.). A data processing system may determine the visual indicators by either identifying hardcoded ratings for the different portions of the pipe or by determining the consequence severity based on set characteristics of the pipe. For example, the data processing system may determine the consequence of a failure for a portion of the pipe by determining a weighted average of the costs to fix the failure, the vulnerability of the population that would be affected by the failure, and/or the likelihood that the failure would affect traffic. The data processing system may similarly determine the consequence severity of a failure for the other portions of the pipe. The data processing system may then select visual indicators (e.g., colors) that correspond to the calculated consequences and add the visual indicators to user interface 400 to graphically show the consequence severities of different portions of the pipe failing. User interface 400 includes a key or legend 402 that indicates the visual indicators for the different consequence severity.

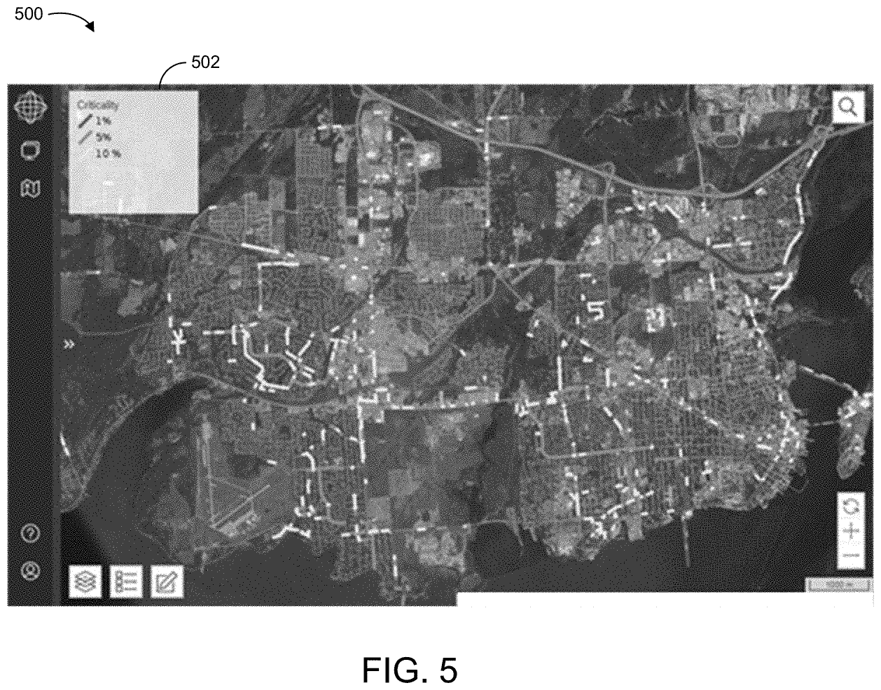

Referring now to FIG. 5, a user interface 500 of an overhead view of a geographic region illustrating a mapping of the criticality score for various portions of an underground pipe in the geographic region is shown, in accordance with some embodiments. Similar to user interface 200, shown and described with reference to FIG. 2, user interface 500 illustrates a geographic region including a municipal area and a wooded area within the geographic region. User interface 500 also illustrates a pipeline that runs underground in the geographic region. The pipeline may be outlined and include visual indicators indicating the criticality of different portions of the pipeline. The criticality for a specific portion of the pipe may indicate how critical it is for the portion of the pipe to be replaced or inspected. A data processing system may determine criticality values for the portions of the pipe based on the consequence severity and failure likelihood for the portion of the pipe. For example, the data processing system may multiply or perform another operation on the consequence severity and failure likelihood values (which may be determined as described herein) for the portion of the pipe. The data processing system may then determine a visual indicator that corresponds to the criticality value. The data processing system may similarly determine criticality values and select visual indicators for other portions of the pipe that are illustrated in user interface 500. The data processing system may add the visual indicators to user interface 500 to graphically show the criticality of replacing or inspecting various portions of the underground pipe. User interface 500 includes a key or legend 502 that indicates the visual indicators for the different criticalities.

As described herein, the different user interfaces 200-500 illustrated in FIGS. 2-5 may be or include selectable graphical overlays that a user may request to view data about the current state of a pipeline within a geographical region. For example, the different types of data that overlay the pipeline shown in user interfaces 200-500 may be selectable filters that a user may toggle between while accessing an application (e.g., a remotely hosted application, such as a software-as-a-service application) via a computer. If the user wishes to view the portions of the pipe that are most likely to experience a failure, the user may select a button to view user interface 200. If the user wishes to view portions of the pipe that are most critical to replace, the user may select a button to view user interface 500. In this way, the application may provide users with the ability to see requested data about areas of the pipeline in real-time to identify where failures are likely to occur in the future. Thus, the application may reduce the need for users to employ any surveyors that rely on leak detection devices to detect failures that have already occurred because any of such leaks will have been addressed before they could occur.

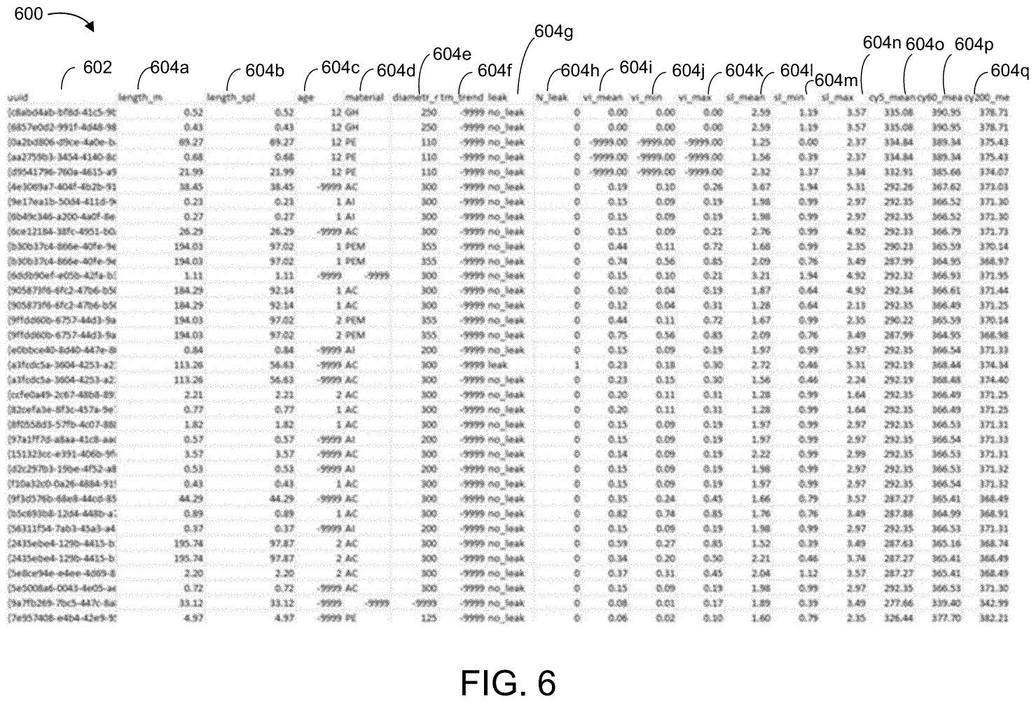

Referring now to FIG. 6, an example of a training data set 600 for training a machine learning model to generate failure likelihood data is shown, in accordance with some embodiments. As illustrated, training data set 600 may include columns for the different types of data that can be input into a machine learning model to obtain failure likelihood data for individual portions of an underground pipe. Training data set 600 may include a column 602 that includes identifications of individual portions or segments of an underground pipe. Each portion may have an individual identifier such that the data for the portion of the pipe is in the same row as the identifier in other columns of training data set 600. Each row of training data set 600 may correspond or include data for a different portion of the pipe. Each portion of the pipe may correspond to one or more pixels of an image of the area in which the pipe is located. Training data set 600 may also include pipe data in columns 604a-e and 604g-h. Columns 604a and 604b may include values indicating the lengths of the individual portions of the pipe. Columns 604c and 604d may include values for the age and material of the individual portions of the pipe. Column 604e may include values for the diameter of the individual portions of the pipe. Columns 604g and 604h may include values indicating which portions of the pipe have experienced a leak or a failure within a set time period. Columns 604g and 604h may be label columns indicating the correct failure predictions for the different portions of the underground pipe. Training data set 600 may include columns 604f and 604i-604q which include various geospatial data (e.g., terrain motion data (e.g., timeseries data), vegetation presence data, soil property data, and/or terrain slope data) for locations that are above and/or within a set radius of the respective portion of the underground pipe (e.g., the values for the geospatial data may characterize the portions of pipe that have unique identifiers in the same rows as the respective geospatial data). A data processing system (e.g., pipeline risk modeler 106) may generate a feature vector of the pipe data of columns 602-604e as well as the geospatial data of columns 604f and 604i-604q and use the feature vector as an input into a machine learning model to obtain predictions for likelihoods of failures occurring in different portions of the underground pipe. The data processing system may compare the predicted likelihoods to the corresponding leak or failure values of columns 604g and/or 604h, determine differences between the predictions and the actual values, and train the machine learning model based on the differences. Accordingly, the data processing system may use training data set 600 to train the machine learning model to predict failures or leaks of different sections of an underground pipe.

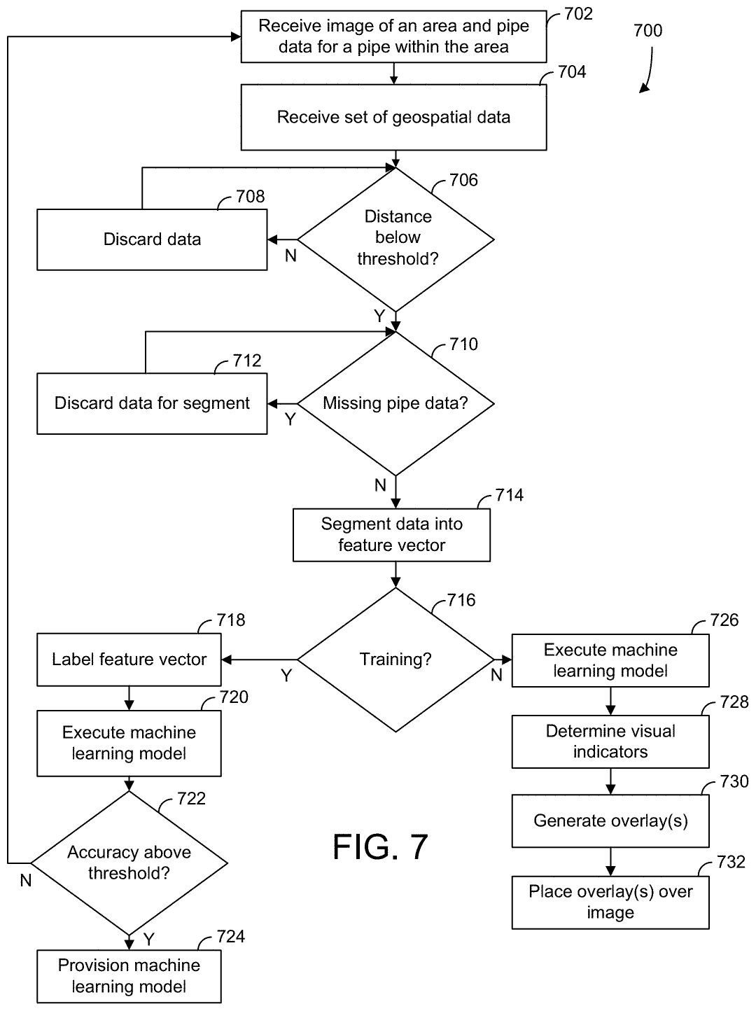

Referring now to FIG. 7, an example method 700 for improved pipe risk modeling is shown, in accordance with some embodiments. Method 700 can be performed by a data processing system (e.g., a client device 102 or 104 or a pipeline risk modeler 106, shown and described with reference to FIG. 1, a server system, etc.). Method 700 may include more or fewer operations and the operations may be performed in any order. Performance of method 700 may enable the data processing system to generate failure likelihood data indicating the likelihood that individual portions or segments of a pipe within a geographical region will experience a failure (e.g., a likelihood that individual portions or segments of the pipe will experience a failure within a set time period). The data processing system may collect pipe data about individual portions or segments of a pipe that is within such a geographical region. Pipe data may include segment length, pipe diameter, pipe age, pipe material, etc. The data processing system may also collect geospatial data of the area surrounding the pipe. Geospatial data may include terrain motion, vegetation presence, soil properties, terrain slope, climate, weather, elevation, etc. The data processing system may segment the data into data that corresponds to individual portions of the pipe and concatenate the segmented data into a feature vector. The data processing system may then input the feature vector into a machine learning model to generate failure likelihood data (e.g., a probability that a failure or leak will occur) for each of the portions of the pipe. The data processing system may then generate an overlay with the failure likelihood data to overlay onto an image of the region such that a user may view which portions of the pipe are likely to fail within a defined time period (e.g., within a time period for which the machine learning model is trained to predict failure likelihood data) and thus need to be inspected and/or replaced. By segmenting the pipe data and geospatial data into segments based on the portions of the pipe to which the respective data corresponds, the machine learning model may accurately predict failure likelihood data for each portion of the pipe. Thus, the machine learning model may predict failure likelihood data that a user can use to address specific portions of the pipe instead of simply knowing a failure is likely to occur in the pipe in general.

At operation 702, the data processing system receives an image of a geographical area. The image may be an optical photograph of the area taken from above the area such as by a satellite or another flying vehicle. The area may include a metropolitan region that includes one or more buildings and/or a forested region that includes various degrees of vegetation. The data processing system may receive the image of the area from an entity or company that specializes in capturing and transmitting such images. For example, the data processing system may receive the image from an ESA Sentinel-2 satellite. Additionally, in some embodiments, the data processing system may receive photographs or radar data of the area such as photographs or radar data collected from ESA Sentinel-1 and/or ALOS-2 PALSAR satellites.

The data processing system also receives pipe data for a pipe that is within the area shown in the image. The pipe may be an underground or above ground pipe. The pipe may be configured to carry water from a water plant to various destinations, such as to houses or commercial businesses. The pipe may transport wastewater and/or potable water. The data processing system may receive the image and the pipe data with a request for failure likelihood data for the pipe. The pipe data may include data about the pipe such as, but not limited to, the lengths of segments of the pipe (e.g., segments of the pipe that have been coupled together or segments of the pipe that have been divided by the data processing system or the source of the data based on their length and position within the pipe), the diameter of the pipe, the age of the pipe, the thickness of the pipe, the material of the pipe, etc. The pipe data may be data for individual portions (e.g., segments) of the pipe. The data processing system may receive the pipe data from an online database, the entity that owns the pipe, or from a data source provider that collects and maintains records about pipes around the country or world.

At operation 704, the data processing system receives geospatial data for a geographic region of the area. The geographic region may be the geographic area and/or coordinates of the area. The geospatial data may include information about the area that is depicted in the image. Examples of geospatial data that the data processing system receives include, but are not limited to, terrain motion data, vegetation presence data, soil property data, and terrain slope data.

At operation 706, the data processing system determines if geospatial data from the set of geospatial data is a distance from the pipe below a distance threshold. The distance threshold may be a defined threshold stored in memory of the data processing system. The data processing system may identify the geographical coordinates that correspond to the individual pieces of geospatial data (e.g., the coordinates of the vegetation data, the terrain movement data, the soil data, and/or the terrain slope data) and the coordinates of the pipe (e.g., coordinates of various portions of the pipe). For one data point of the geospatial data (e.g., geospatial data at set of coordinates), the data processing system may determine the distances between the coordinates for the data point and the coordinates for different portions of the pipe using a distance formula. The data processing system may then compare the determined distances to a threshold. If the data processing system determines none of the distances are below a threshold, at operation 708, the data processing system discards the data point of the geospatial data (e.g., remove the data point from memory or otherwise exclude the data point from a data set that is being used to generate failure likelihood data for a pipe). The data processing system may similarly determine whether the data points of the geospatial data are within a distance of the pipe below a threshold and discard any data that is not close to the pipe. Thus, the data processing system can filter out the geospatial data that is likely not relevant to determining the failure likelihood for the pipe. By doing so, the data processing system can minimize the data that is put into a machine learning model while still enabling the machine learning model to generate accurate failure likelihood data.

At operation 710, the data processing system determines if the pipe data for the pipe is complete. For example, the data processing system may store rules that indicate whether pipe data that the data processing system receives is complete. An example rule may be that data for a particular portion of a pipe is complete if the data includes values for the material, diameter, and age of the portion of the pipe. The rule may also include a requirement that the data include an identifier indicating whether the portion of the pipe is active or replaced. The rule may include requirements that the data include any type or any number of values. The data processing system may identify the values (or lack thereof) for each type of pipe data and generate a binary indicator indicating whether the data point for the section of the pipe has a value for the data type. The data processing system may compare the binary values to the rule to determine if the rule is satisfied. Thus, the data processing system may determine if the pipe data is complete and avoid using incomplete data that may skew the accuracy of failure likelihood data for the portion of the pipe for which there is incomplete data.

If the data processing system determines data is missing that is required by a rule, at operation 712, the data processing system discards the data for the portion of the pipe to which the geospatial data corresponds. The data processing system may discard the data by removing the data from memory of the data processing system or otherwise excluding the data from the dataset that is being used to predict failure likelihood data for the pipe. In doing so, the data processing system may discard all of the pipe data for the portion of the pipe. The data processing system may also discard the geospatial data for the portion of the pipe. For example, the data processing system may identify any geospatial data that is within a threshold distance of the portion of the pipe as being associated with the portion of the pipe. The data processing system may discard the identified geospatial data responsive to determining the geospatial data is within the threshold distance of the portion of the pipe with incomplete pipe data. The data processing system may iteratively repeat operations 710 and 712 for each portion of the pipe for which the data processing system receives data.

In some embodiments, before discarding geospatial data for a portion of the pipe, the data processing system may determine if the geospatial data is within the distance threshold of another portion of the pipe. For example, if the geospatial data has coordinates that are within five meters of multiple defined portions of the pipe, the data processing system may determine the geospatial data will still be used in the dataset with the portions of the pipe that have or that are otherwise associated with a complete set of pipe data and that are within the distance threshold of the geospatial data. For example, the distance threshold may be five meters. The data processing system may identify geospatial data that is within five meters of multiple defined portions of the pipe. The data processing system may identify the portions of the pipe for which there is not a complete set of pipe data and/or geospatial data and the portions of the pipe for which there is a complete set of pipe data and/or geospatial data. Because the data processing system has identified portions of the pipe for which there is a complete set of pipe data, the data processing system may not discard the associated geospatial data and instead only use the geospatial data for the portions of the pipe for which there is a complete set of pipe data.

At operation 714, the data processing system segments the data into a feature vector. The data processing system may segment the data into a feature vector based on the portions of the pipe to which the data corresponds. For example, the data processing system may identify unique identifiers of portions (e.g., divided portions) of a pipe. In some embodiments, the data processing system only identifies unique identifiers of portions of the pipe for which pipe data and/or geospatial data has not been discarded, as described above. The data processing system may identify pipe data from a set of pipe data for the pipe that characterizes the individual portions of the pipe and assign the pipe data to the unique identifiers for the portions of the pipe. Similarly, the data processing system may identify geospatial data that has coordinates within a distance threshold of the different portions of the pipe. The data processing system may identify the unique identifiers for the different portions of the pipe with which the geospatial data is within a distance threshold and assign the geospatial data to the unique identifiers of the portions of the pipe to which the geospatial data corresponds.

In some embodiments, the data processing system assigns the pipe data and the geospatial data to unique identifiers of segments of a pipe by grouping the pipe data, the geospatial data, and the unique identifiers that are assigned together in a feature vector. For example, the data processing system may assign a unique identifier and pipe and geospatial data to sequential index values of a feature vector (e.g., the first value of the feature vector may be the unique identifier, the second through fifth values may be different pipe data characteristics, and the sixth through tenth values may be geospatial characteristics (e.g., variables)). After adding the data for one portion of the pipe, the data processing system may similarly add data for additional portions of the pipe in the same or in a similar manner. In this way, the data processing system may generate a feature vector such that a machine learning model may generate failure likelihood data for individual portions of the pipe.

In some embodiments, if data for an individual portion of the pipe has been discarded for having an incomplete set of pipes and/or inapplicable geospatial data (e.g., geospatial data that is too far from a portion of the pipe), the data processing system sets the index values for the portion of the pipe as null values. The data processing system may do so by setting all of the values to null including the unique identifier for the portion of the pipe or by including the unique identifier itself in the feature vector and setting the data for the portion of the pipe to null. In some embodiments, the data processing system excludes all of the data for the portions of the pipe for which there is incomplete and/or inapplicable data from the feature vector. Instead, the data processing system adds only the portions for which there is complete data. By doing so, the data processing system may avoid making predictions for portions of the pipe for which there is incomplete or inapplicable data and/or making predictions for other portions of the pipe that are affected by the incomplete or inapplicable data.

In some embodiments, the data processing system assigns the pipe data and the geospatial data to the unique identifiers in a spreadsheet. For example, the data processing system may generate a spreadsheet in which each row includes data for a specific portion of a pipe and each column includes data for specific pipe data or geospatial data for the portions of the pipe. The data processing system may identify the pipe data and the geospatial data that is associated with each of the portions of the pipe and insert the identified data into the rows that correspond to the portions of the pipe (e.g., the data processing system may insert pipe data and geospatial data for a portion of a pipe into the same row as the unique identifier for the portion of the pipe). In some embodiments, the data processing system inserts data for discarded portions of the pipe into the spreadsheet as null values to avoid processing the incomplete or inapplicable data while maintaining a record of the portion of the pipe (e.g., include the unique identifiers for such portions of the pipe but only add null values for the different columns of the rows). The data processing system may insert the different types of data into the spreadsheet such that the columns for the pipe data are next to each other and the columns for the geospatial data are grouped together after the columns for the pipe data. This may be useful to avoid extra processing that may be caused by reorganizing the data after the pipe data and geospatial data are input into the data processing system as separate data sets. The generated spreadsheet may be a feature vector that can be input into a machine learning model for processing to determine failure likelihood for different portions of the pipe.

In some embodiments, the data processing system generates a feature vector from the spreadsheet. For example, the data processing system may extract values from the spreadsheet and concatenate the values to generate a feature vector. In doing so, the data processing system may assign the values for each row to the feature vector sequentially such that the values for the portions of the pipe are grouped together to determine the failure likelihood data for the different portions of the pipe.

In some embodiments, the data processing system discards data for portions for the pipe for which there is incomplete or inapplicable data prior to adding the data to the spreadsheet or avoid using such data to generate failure likelihood data. For instance, the data processing system may insert the data into the different rows of the spreadsheet after filtering the incomplete or inapplicable data out of the data set. By doing so, the data processing system may avoid inserting incomplete or inapplicable data into the machine learning model when processing the spreadsheet.

In some embodiments, the data processing system may include data for portions of the pipe for which there is incomplete or inapplicable data in the spreadsheet, but not use the data when generating a feature vector. In one example, the data processing system may label portions of the pipe for which there is incomplete or inapplicable data as discarded in memory. When generating a feature vector from the spreadsheet, the data processing system may identify any rows from the spreadsheet that correspond to a discarded portion of the pipe (e.g., identify rows with a unique identifier that matches a unique identifier that is stored in memory with a discarded identifier) and skip adding data from the identified rows. In some embodiments, the data processing system may add data for such portions into the feature vector as null values as described above. By doing so, the data processing system may maintain a record of the data in the spreadsheet that a user may update with additional data to use for a future prediction instead of deleting the data so the data could not be used again.

At operation 716, the data processing system determines if the feature vector is being used to train the machine learning model. The data processing system may do so by determining if the data includes any labels that correspond to whether a failure occurred within the portions of the pipe. For example, the data processing system may parse a spreadsheet to determine if there is a column for “leak” values (e.g., “leak” or “no_leak”) that indicates whether individual portions of the pipe experienced a leak. If the data processing system identifies such a column, the data processing system may determine the input feature vector is to be used for training, otherwise, the data processing system may determine the input feature vector is not to be used for training. In some embodiments, the data processing system determines if the feature vector is to be used for training based on whether the instructions that the data processing system is processing include instructions to train the machine learning model according to labels indicating whether any leaks occurred in individual portions of the pipe. In some embodiments, the data processing system determines the feature vector is being used to train the machine learning model in response to identifying leak values from the pipe data that the data processing system receives to make a failure likelihood prediction (e.g., identifying leak values in the data prior to generating a spreadsheet with the data).

At operation 718, the data processing system labels the feature vector responsive to determining the data processing system is training a machine learning model. The data processing system may label the feature vector by inserting leak values indicating whether a leak occurred in the different portions of the pipe into the feature vector or into a column in a spreadsheet that is dedicated to such leak values. The data processing system may insert such leak values into a feature vector as a pair with the values for the portion of the pipe and/or into the same row as the other values for the portion of the pipe. The data processing system may insert the leak values into the feature vector or spreadsheet such that the data processing system may later retrieve the values to use to train the machine learning model to predict failure likelihoods for the individual portions of the pipe.

In some embodiments, the data processing system only uses data that has been labeled for training or otherwise labels a training data set if the failures identified in the labels satisfy a criterion stored in the data processing system. For example, for a training data set, the data processing system may check a historical failure database to identify the failures for the portions of the pipe in the data set. The data processing system may determine if the failures have coordinates identifying where the failures occurred or a precise address (e.g., an address that can be geocoded such as through an API to a map application) to generate a pair of coordinates from the address. The data processing system may also identify the cause of the failure from the database and determine if the failure was caused by human intervention or by environmental factors. The data processing system may discard any training data for portions of the pipe that indicates a failure occurred in the portion that was caused by human intervention or where the address is incomplete (e.g., house number is missing) to ensure the accuracy of the training data. Thus, the data processing system may avoid improperly biasing the machine learning model during training.

At operation 720, the data processing system executes the machine learning model. The machine learning model may be any type of machine learning model (e.g., a neural network, a support vector machine, random forest, a regression algorithm such as a gradient boosting algorithm, etc.). The data processing system may execute the machine learning model by inserting the feature vector or spreadsheet into the machine learning model. Upon executing the machine learning model, the data processing system may apply the parameters and weights of the machine learning model to the input values. The machine learning model may output a failure likelihood for each of the portions of the pipe (e.g., a likelihood that the respective portion of the pipe will experience a fault, leak, or other failure within a set time period (e.g., one year)) for which the data processing system input data. The data processing system may retrieve the output failure likelihoods for the different portions of the pipe and train the machine learning model based on the likelihoods.

To train the machine learning model based on the output failure likelihoods, the data processing system may use a backpropagation technique based on the labels for the different portions of the pipe. For example, after receiving the output failure likelihoods, the data processing system may compare the output with the expected output (e.g., labels indicating whether a failure or “leak” occurred) for the different portions of the pipe. The data processing system may then use a loss function or another supervised training technique based on the differences between the two values for the individual portions of the pipe to train the machine learning model. The data processing system may use backpropagation to determine a gradient for the respective loss function and update the weights and/or parameters of the machine learning model using the gradient, such as by using gradient descent techniques.

At operation 722, the data processing system determines if the machine learning model has an accuracy that exceeds an accuracy threshold. The accuracy threshold may be a defined threshold that is stored in memory of the data processing system that may be used to determine if machine learning models are sufficiently trained to be used to make failure likelihood predictions for new unlabeled datasets. The data processing system may determine the accuracy of the machine learning model by comparing the output failure likelihoods for the different portions of the pipe with the leak or failure label. The data processing system may calculate an average of the differences between the portions of the pipe and the labels to determine the accuracy of the machine learning model. For example, if the predicted failure likelihood values for two portions of a pipe were 70 percent and 80 percent and both portions had a failure or leak label, the data processing system may determine the accuracy of the machine learning model was 75 percent by calculating the differences between the predictions and the correct value, taking an average of the predictions, and subtracting the average from the value 1. If the same set of data had “no_leak” or “no failure” labels, however, the data processing system may determine the accuracy of the machine learning model was 37.5%. The data processing system may compare the determined accuracy to the accuracy threshold. If the data processing system determines the accuracy is not above the accuracy threshold, the data processing system may repeat operations 702-722 until the data processing system determines the machine learning model is sufficiently trained (e.g., has an accuracy above the accuracy threshold).

If the data processing system determines the determined accuracy is above the accuracy threshold, at operation 724, the data processing system provisions the machine learning model. The data processing system may provision the machine learning model by making the machine learning model available in a software-as-a-service environment and/or by transmitting the machine learning model to an entity requesting the machine learning model. For example, upon determining the machine learning model is sufficiently trained, the data processing system may receive requests for failure likelihood predictions for different pipes in different regions. The data processing system may receive the requests with sets of pipe data and/or geospatial data of the regions and predict failure likelihood data for the different sections of the pipe with the machine learning model. The data processing system may transmit the predicted data back to the requesting device in response to the request. In embodiments in which the data processing system transmits the machine learning model to other devices, such devices may similarly generate feature vectors and/or spreadsheets with pipe data and/or geospatial to make failure likelihood predictions.

In some embodiments, when training the machine learning model, the data processing system may train the machine learning model by dividing training data into a training time period and a testing time period. For example, the data processing system may receive pipe data and geospatial data for a particular pipe and/or geographic region over four sequential years. The data may be divided into four data sets, a data set for each of the four years. The data for the first three years may be training data sets and the data for the fourth year may be a test data set. For example, if a water company has recorded pipe failure data for a pipe from 2017 to 2020, all failures recorded in 2020 would be included in the test data set, while failures recorded from 2017 to 2019 are in the training data set. The data may include data from the most recent number (e.g., a predetermined number) of years for which a water company collected failure data. In some cases, the test dataset includes the last year where failures were recorded by a water company, while the training set includes the remaining years. The training data and the test data may each include data for any number of years and/or any other time period (e.g., day, week, month, etc.).

In embodiments in which the data processing system divides data sets into training and testing, the data processing system may train the machine learning model using the data from the training dataset and then test the machine learning model using the testing data set. For example, if the data processing system received separate data sets for a pipe over a four-year period, the data processing system may generate a feature vector from the data for each of the four years. The data processing system may apply labels indicating the correct prediction for a failure likelihood (e.g., an indication of whether a failure occurred in the respective portions of the pipe during the respective years) to the feature vectors for the first three years and train the machine learning model based on the three labeled feature vectors. The data processing system may then apply the feature vector for the testing time period to the machine learning model to obtain failure likelihood predictions for the testing time period. The data processing system may compare predicted values to the actual values to determine the current accuracy of the machine learning model. The data processing system may determine if the accuracy exceeds an accuracy threshold by comparing the accuracy to the threshold. In some embodiments, if the data processing system determines the accuracy exceeds the threshold, the data processing system may merge or concatenate the data sets for the four years together (e.g., if the four years were 2017 to 2020, merge the failure data from the beginning of 2017 to the end of 2020) and train the machine learning model using all of the data. Thus, the data processing system may fit the machine learning model to the complete data set.

Advantageously, by training the machine learning model in this manner, the data processing system may provision the machine learning model to predict failures for individual portions of pipes over an entire pipe network. The data processing system may receive the failure likelihood outputs from the machine learning model, compare the likelihoods to a flag threshold (e.g., a predetermined flag threshold), and generate flags for each portion of the pipe with a failure likelihood that exceeds the threshold. Thus, the data processing system may use the machine learning model to predict failures in pipe portions that have not necessarily failed in the past but are prone to failure because they share one or more characteristics (e.g., physical characteristics such as material or age and/or environmental characteristics such as corrosive soil) with other pipe portions that have failed in a past observation period.

Returning to operation 716, if the data processing system determines the data set is not being used to train the machine learning model, at operation 726, the data processing system executes the machine learning model. The data processing system may execute the machine learning model by inputting the spreadsheet or feature vector of pipe and geospatial data into the machine learning model. Upon executing the machine learning model, the machine learning model may output failure likelihood data for individual portions of the pipe. In some embodiments, upon generating the failure likelihood data, the data processing system transmit the failure likelihood data to a device that requests failure likelihood data for the region or that sent a request to cause the data processing system to generate the failure likelihood data.

At operation 728, the data processing system determines visual characteristics for the portions of the pipe. The data processing system may determine visual characteristics of the pipe based on the failure likelihood for the individual portions. The data processing system may determine one or more layers of visual characteristics for the individual portions of the pipe based on the portions' respective failure likelihood. In brief overview, the different layers may include failure likelihood, priority risk zones, consequence severity, and/or criticality of failure.

The data processing system may select visual indicators for the failure likelihood layer based on the predicted failure likelihoods for the individual portions of the pipe. For example, the data processing system may store a set of colors that may each correspond to a different failure likelihood value in memory. In some embodiments, the set of colors may correspond to a color scale from blue to red with dark blue corresponding to the lowest failure likelihood and dark red corresponding to the highest failure likelihood. The data processing system may identify the failure likelihoods for the portions of the pipe from the output of the machine learning model and use the failure likelihoods as a look-up to identify the corresponding colors in memory. The data processing system may retrieve the colors for the different portions of the pipe based on the colors corresponding to a matching value in memory.

The data processing system may determine the priority risk zone by applying a clustering algorithm to the failure likelihood data. In doing so, the data processing system may create management areas based on failure likelihood data for the different portions of the pipe within the respective area. The data processing system may group different portions of a pipe based on their proximity to each other and their failure likelihood. Using one example of such a clustering algorithm, the data processing system may group different portions of the pipe together responsive to the portions being within a defined distance range of each other and/or having a failure likelihood within a failure likelihood range. For instance, the data processing system may create a group of portions of a pipe that are within 25-meter range of each other and that have a predicted failure likelihood between 70% and 80%. Using another example clustering algorithm, the data processing system may group portions of a pipe together according to various spatial and/or hydraulics rules. For instance, the data processing system may group portions of a pipe together that either have a predicted failure likelihood above a threshold or that are immediately adjacent to or within a defined number of pipe portions or within a distance of a pipe portion that is likely to experience a failure. Such may be advantageous because if one portion of a pipe experiences a failure, it may be more likely that the surrounding portions of the pipe will also experience a failure or that the surrounding pipes need to be investigated or replaced to reduce the possibility of a failure in the identified portion of the pipe. Using another example clustering algorithm, the data processing system may identify clusters based on their average failure likelihood exceeding a threshold. For instance, the data processing system may identify individual sub-regions of the area of the pipe that contain failure likelihood data for portions of the pipe that is above or below the threshold. Such areas may be any size.

Upon clustering the portions of the pipe together, the data processing system may select visual indicators for the portions of the pipe based on the clusters. For instance, the data processing system may identify a cluster of pipe portions that have or that are associated with a high likelihood (e.g., a likelihood above a threshold) of experiencing a failure. Accordingly, the data processing system may select a color (e.g., red) that corresponds to having a high likelihood of experiencing a failure from memory. The data processing system may identify a cluster of pipe portions that have a low likelihood of experiencing a failure. In this case, the data processing system may select a color (e.g., blue) that corresponds to having or being associated with a low likelihood (e.g., a likelihood below a threshold) of experiencing a failure. The data processing system may select any colors based on the characteristics of such a cluster. Thus, water companies that view the visual indicators can prioritize investigation and pipe repair in the areas of the pipe that are most at risk in their proactive management.

In some embodiments, the data processing system clusters pipe portions based on the district metered areas (DMA) in which they are located. To do so, the data processing system may identify the pipe portions that are within individual district meter areas (e.g., identify pipe portions that have coordinates in different district metered areas or that have a stored association with district metered areas) and determine an average of the failure likelihoods for the different district metered areas. The data processing system may compare the average to colors in a database and select the color that corresponds to the average to assign to each of the pipe portions in the district metered areas.

The data processing system may select visual indicators for the portions of the pipe based on consequence severities for the individual portions of the pipe. Consequence severities may not be dependent on the failure likelihood that is predicted by the machine learning model, but rather may describe the inherent risk that each portion of the pipe poses to the water company and the community in case of catastrophic failure. Consequence severity values may vary between the entities that request such values. For instance, one entity may only view risks such as disruption to the supply of vulnerable customers (e.g., hospitals or schools in their consequence severity values) as impacting the consequence severity values. Another entity may only view risks such as traffic disruptions as impacting the consequence severity values. Another entity that manages the water network in old towns and cities may view pipes running through the old towns as more at risk because repairing or replacing these would incur additional costs. Accordingly, the data processing system may store different values for the consequence severities for different entities for the different pipe portions, geographic locations, and/or coordinates. The data processing system may retrieve the values upon receiving a request for consequence severity data and/or other failure likelihood data depending on the entity that is making a request (e.g., use an identifier of the requesting entity in a look-up to identify the consequence severity values for the different portions of the pipe).

In some embodiments, the data processing system determines consequence severity values for the different pipe portions. The consequence severity values may be values between 1 and 100 that indicate the severity of the impact that a failure in the particular portion of the pipe would have if it were to experience a failure. The data processing system may determine the consequence severity based on the direct cost of response, repair and restoration of a break, and/or the indirect costs of the impact, including the proximity to vulnerable buildings, service disruption to customers, collateral damage and/or transport disruption. The data processing system may store a machine learning model that is trained to output consequence severity values based on such variables and execute the machine learning model for the individual portions of the pipe based on the data. In another example, cost information may not be available to the data processing system. In such instances, or additionally, the data processing system can execute a machine learning model that has been trained to predict consequence severity values for portions of a pipe using pipe diameter, historic volume of water loss, and proximity to vulnerable buildings data (e.g., hospitals or schools).

The data processing system may select visual indicators for the different portions of the pipe based on the consequence severity values for the different pipe portions. For example, the data processing system may store colors that correspond to the different consequence severity values similar to the colors for the failure likelihood data in memory. The data processing system may use the consequence severity values in a look-up from memory to identify the colors that correspond to the consequence severity values for the different portions of the pipe.

In some embodiments, the data processing system can determine criticality scores for the different pipe portions. The data processing system may do so based on a combination of the consequence severity values and failure likelihood values for the individual portions of the pipe. For example, for a portion of the pipe, the data processing system may identify the failure likelihood and the consequence severity for the portion. The data processing system may determine an average, a weighted average, a multiple, a sum, or any other operation, for the two values to determine a criticality score for the pipe portion. The data processing system may similarly determine criticality scores for each of the pipe portions for which the data processing system determined a failure likelihood. Thus, the data processing system may highlight the portions of the pipe that need to be inspected or replaced to improve the overall health of the pipe.

The data processing system may select visual indicators for the different portions of the pipe based on the criticality scores for the different pipe portions. For example, the data processing system may store colors that correspond to the different criticality scores similar to the colors for the failure likelihood data in memory. The data processing system may use the criticality scores in a look-up from memory to identify the colors that correspond to the criticality scores for the different portions of the pipe.

At operation 730, the data processing system may generate an overlay from the visual indicators. The data processing system may do so by identifying the pixels of the image the data processing system received at operation 702 that correspond to the portions of the pipe for which failure likelihood data and visual characteristics were generated. The data processing system may assign the visual indicators to the corresponding pixels and generate an overlay with pixels that mirror the pixels of the image. In embodiments in which the data processing system determines visual indicators for the different layers (e.g., priority risk zones, consequence severity, and/or criticality of failure), the data processing system may similarly generate an overlay for each of the layers. The data processing system may store the overlays in memory such that the overlays may be retrieved upon receiving a request from a client device.

At operation 732, the data processing system places the overlays over the image. The data processing system may place (e.g., append) the overlays over the image in response to receiving a request from a client device (or in response to the original request requesting an analysis of the pipe data and geospatial data). The data processing system may receive a request to see the overlay for one of the layers for which the data processing system determined visual indicators of failure likelihood. The data processing system may then place the requested overlay over the image of the area such that the user can see the visual indicators over the portions of the pipe that the visual indicators represent and view which portions are most at risk of experiencing a failure and/or need to be addressed. A user viewing the user interface may select an option to view another of the layers. In response to this request, the data processing system may remove the initial overlay or visual indicators from the user interface and place the new requested overlay over the image, thus toggling between the different visual indicators and/or overlays to give the user a broad view of the failure likelihood in different portions of the pipe. The data processing system may toggle between any number of visual indicators or overlays.

It is to be understood that any examples, values, graphs, tables, and/or data used herein are simply for purposes of explanation and are not intended to be limiting in any way. Further, although the present disclosure has been discussed with respect to potable water pipes risk, in other embodiments, the teachings of the present disclosure may be applied to similarly monitor other networks.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for reducing pipe failure risk, comprising:
receiving, by a processor, an image depicting an overhead view of an area and a set of pipe data indicating characteristics for an underground pipe that is located within the area;
receiving, by the processor, a set of geospatial data for a geographic region in which the area is located;
segmenting, by the processor, the set of pipe data and the set of geospatial data for the geographic region into a plurality of segments to generate a feature vector, each of the plurality of segments corresponding to a separate portion of the underground pipe;
executing, by the processor, a machine learning model using the feature vector to generate failure likelihood data for the separate portions of the underground pipe;
determining, by the processor, visual indicators that correspond to the generated failure likelihood data for the separate portions of the underground pipe; and
generating, by the processor, an overlay from the visual indicators, the overlay comprising the visual indicators for pixels of the image that correspond to the separate portions of the underground pipe.

2. The method of claim 1, wherein segmenting the set of pipe data and the set of geospatial data comprises discarding, by the processor, geospatial data from the set of geospatial data responsive to the geospatial data corresponding to a location above a predetermined distance from the underground pipe.

3. The method of claim 1, further comprising training, by the processor, the machine learning model using historical failure data of the separate portions of the underground pipe.

4. The method of claim 1, further comprising training, by the processor, the machine learning model by:
receiving, by the processor, a second set of pipe data and failure data for the separate portions of the underground pipe from a first time period, the failure data indicating whether a failure occurred in each of the respective portions of the underground pipe during the first time period;
receiving, by the processor, a second set of geospatial data for the geographic region in which the area is located from the first time period;
segmenting, by the processor, the second set of pipe data and the second set of geospatial data for the geographic region into a second plurality of segments to generate a second feature vector, each of the second plurality of segments corresponding to a separate portion of the underground pipe;
using the failure data, labeling, by the processor, each of the second plurality of segments of the feature vector with a flag indicating whether a failure occurred in the portion of the underground pipe that corresponds to the respective segment during the first time period; and
training, by the processor, the machine learning model with the feature vector comprising the labeled segments.

5. The method of claim 4, wherein training the machine learning model comprises:
receiving, by the processor, a third set of pipe data and second failure data for the separate portions of the underground pipe from a second time period subsequent to the first time period, the second failure data indicating whether a failure occurred in each of the respective separate portions of the underground pipe during the second time period;
receiving, by the processor, a third set of geospatial data for the geographic region in which the area is located from the second time period;
segmenting, by the processor, the third set of pipe data and the third set of geospatial data for the geographic region into a third plurality of segments to generate a third feature vector, each of the third plurality of segments corresponding to a separate portion of the underground pipe;
executing, by the processor, the machine learning model to generate second failure likelihood data for the separate portions of the underground pipe; and
comparing, by the processor, the second failure likelihood data with the second failure data to determine an accuracy of the machine learning model.

6. The method of claim 5, further comprising:
provisioning, by the processor, the machine learning model in response to the accuracy of the machine learning model exceeding a threshold.

7. The method of claim 1, wherein receiving the set of geospatial data for a geographic region in which the area is located comprises receiving, by the processor, terrain motion timeseries data, vegetation presence data, soil property data, or terrain slope data.

8. The method of claim 1, wherein receiving the set of pipe data comprises receiving, by the processor, pipe diameter data, pipe material data, or pipe age data.

9. The method of claim 1, wherein determining the visual indicators comprises selecting, by the processor, a color for each portion of the underground pipe based on the failure likelihood data for the respective portions of the underground pipe.

10. The method of claim 1, wherein segmenting the set of pipe data and the set of geospatial data for the geographic region comprises:
determining, by the processor, whether a portion of the underground pipe has been labeled with an active or replaced label in the set of pipe data; and
discarding, by the processor, pipe data and geospatial data for the portion of the underground pipe in response to determining the portion of the underground pipe has not been labeled with an active or replaced label.

11. The method of claim 1, wherein segmenting the set of pipe data and the set of geospatial data for the geographic region comprises:
determining, by the processor, whether the set of pipe data comprises a material value, a diameter value, and an age value for a portion of the underground pipe; and
discarding, by the processor, pipe data and geospatial data for the portion of the underground pipe in response to determining the set of pipe data does not comprise one of a material value, a diameter value, or an age value for the underground pipe.

12. The method of claim 1, wherein the failure likelihood data for a portion of the underground pipe comprises a likelihood that a failure will occur in the portion of the underground pipe, and wherein determining the visual indicator that corresponds to the generated failure likelihood data for the separate portions of the underground pipe comprises:
identifying, by the processor, a sub-region of the area that contains failure likelihood data for portions of the underground pipe with an average above a threshold; and
selecting, by the processor, a color for each portion of the underground pipe that is located within the sub-region of the area based on the average being above the threshold.

13. The method of claim 1, wherein determining the visual indicator that corresponds to the generated failure likelihood data for the separate portions of the underground pipe comprises:
selecting, by the processor, a color for a portion of the underground pipe based on a consequence severity if the portion of the underground pipe experiences a failure.

14. The method of claim 1, wherein determining the visual indicator that corresponds to the generated failure likelihood data for the separate portions of the underground pipe comprises:
determining, by the processor, a criticality score for a portion of the underground pipe based on a consequence severity of the underground pipe if the portion of the underground pipe experiences a failure and the failure likelihood data for the portion of the underground pipe; and
selecting, by the processor, a color for the portion of underground pipe based on the criticality score.

15. The method of claim 14, wherein determining the criticality score comprises determining, by the processor, a weighted average of the consequence severity and the failure likelihood data for the portion of the underground pipe.

16. A system for reducing pipe failure risk, comprising:
a processor configured by machine-readable instructions to:
receive an image depicting an overhead view of an area and a set of pipe data indicating characteristics for an underground pipe that is located within the area;
receive a set of geospatial data for a geographic region in which the area is located;
segment the set of pipe data and the set of geospatial data for the geographic region into a plurality of segments to generate a feature vector, each of the plurality of segments corresponding to a separate portion of the underground pipe;
execute a machine learning model using the feature vector to generate failure likelihood data for the separate portions of the underground pipe;
determine visual indicators that correspond to the generated failure likelihood data for the separate portions of the underground pipe; and
generate an overlay from the visual indicators, the overlay comprising the visual indicators for pixels of the image that correspond to the separate portions of the underground pipe.

17. The system of claim 16, wherein the processor is configured to segment the set of pipe data and the set of geospatial data by discarding geospatial data from the set of geospatial data responsive to the geospatial data corresponding to a location above a predetermined distance from the underground pipe.

18. The system of claim 16, wherein the processor is further configured to train the machine learning model using historical failure data of the separate portions of the underground pipe.

19. A non-transitory computer-readable storage medium having instructions embodied thereon, the instructions being executable by a processor to perform a method for reducing pipe failure risk, the method comprising:
receiving an image depicting an overhead view of an area and a set of pipe data indicating characteristics for an underground pipe that is located within the area;
receiving a set of geospatial data for a geographic region in which the area is located;
segmenting the set of pipe data and the set of geospatial data for the geographic region into a plurality of segments to generate a feature vector, each of the plurality of segments corresponding to a separate portion of the underground pipe;
executing a machine learning model using the feature vector to generate failure likelihood data for the separate portions of the underground pipe;
determining visual indicators that correspond to the generated failure likelihood data for the separate portions of the underground pipe; and
generating an overlay from the visual indicators, the overlay comprising the visual indicators for pixels of the image that correspond to the separate portions of the underground pipe.

20. The non-transitory computer-readable storage medium of claim 19, wherein segmenting the set of pipe data and the set of geospatial data comprises discarding geospatial data from the set of geospatial data responsive to the geospatial data corresponding to a location above a predetermined distance from the underground pipe.
